(19) United States
(12) Patent Application Publication
(10) Pub. No.: US 2025/0093886 A1
(43) Pub. Date: Mar. 20, 2025

(54) MAINTENANCE-OF-WAY SYSTEM AND METHOD

(71) Applicant: Transportation IP Holdings, LLC, Norwalk, CT (US)

(72) Inventors: Mark Bachman, Albia, IA (US); Michael VanderLinden, Knoxville, IA (US); Norman Wellings, Agency, IA (US); Mark Bradshaw Kraeling, West Melbourne, FL (US); Shawn A. McClintic, Erie, PA (US)

(73) Assignee: Transportation IP Holdings, LLC, Norwalk, CT (US)

(21) Appl. No.: 18/967,525

(22) Filed: Dec. 3, 2024

Related U.S. Application Data
(63) Continuation-in-part of application No. 17/461,930, filed on Aug. 30, 2021.
(60) Provisional application No. 63/072,586, filed on Aug. 31, 2020.

(51) Int. Cl. G05D 1/689; A01M 21/04

(52) U.S. Cl. CPC G05D 1/689; A01M 21/043

(57) ABSTRACT

A maintenance of way system having a vehicle is described herein. The vehicle may include an emitter adjustable to selectively focus on a targeted feature within an operating vicinity of the vehicle a control circuit communicatively coupled to the emitter. The control circuit may determine a parameter associated with the operating vicinity of the vehicle, detect the targeted feature based, at least in part, on the parameter, adjust the emitter to selectively focus the emitter with respect to the targeted feature, and cause the emitter to direct an emission toward the targeted feature while sparing non-targeted features within the operating vicinity.

### CROSS-REFERENCE TO RELATED APPLICATIONS

The present application is a continuation-in-part of U.S. Non-Provisional patent application Ser. No. 17/461,930 titled VEHICLE WITH SPRAY CONTROL SYSTEM AND METHOD, filed Aug. 30, 2021, which claims priority to U.S. Provisional Application No. 63/072,586, filed on Aug. 31, 2020, the disclosures of which are incorporated by reference in their entirety herein.

### BACKGROUND

### Technical Field

Embodiments of the subject matter disclosed herein relate to a vehicle having vision-based systems and methods of maintaining and/or improving the condition of vehicle routes, including the selective elimination of unwanted obstructions.

### Discussion of Art

Vegetation growth can be a dynamic aspect for routes such as paths, tracks, roads, etc. Over time, vegetation can grow in such a way as to interfere with travel over the route and must be managed. Vegetation management may be time and labor intensive. For both in-vehicle and wayside camera systems, these camera systems may capture information relating to the state of vegetation relative to a route, but that information sometimes is not actionable.

Some current maintenance of way systems may be mountable on a vehicle, such systems may maintain routes without consideration of parameters that could otherwise lead to better route maintenance. For example, spray systems may blindly spray herbicide along a route, inadvertently eliminating beneficial plants that do not obstruct the route in an attempt to eliminate harmful weeds that do obstruct the route. Additionally, certain potions of a route may not be obstructed (e.g., routes that pass along a cliff on one side), resulting in a waste of resources by blindly maintaining the unobstructed portion of the route. Some currently available systems may blindly maintain routes without consideration of a specific targeted object (e.g., vegetation, fire, debris) and/or environmental parameters (e.g., weather) that could otherwise lead to relatively improved maintenance of the route. It may be desirable to have a system and method for a maintenance of way system that differs from those that are currently available.

### BRIEF DESCRIPTION

In one embodiment, a vehicle system is provided that can traverse, fill, and empty compatible cars in remote environments without access to traditional ground equipment. The vehicle system can be used for managing aspects of maintenance of way (MoW).

In another embodiment, a vehicle including an emitter adjustable to selectively focus on a targeted feature within an operating vicinity of the vehicle, and a control circuit communicatively coupled to the emitter is provided. The control circuit can be configured to determine a parameter associated with the operating vicinity of the vehicle, detect the targeted feature based, at least in part, on the parameter, adjust the emitter to selectively focus the emitter with respect to the targeted feature, and cause the emitter to direct an emission toward the targeted feature while sparing non-targeted features within the operating vicinity.

In still another embodiment, a method is provided, including the steps of, determining a parameter associated with an operating vicinity of a vehicle, distinguishing a targeted feature from a non-targeted feature based, at least in part, on the parameter, adjusting an emitter to selectively focus the emitter with respect to the targeted feature, and activating the emitter to direct an emission exclusively and only toward the targeted feature and not toward a non-targeted feature within the operating vicinity.

According to another embodiment, a system including a control circuit is provided. The control circuit can be configured to determine a parameter associated with an operating vicinity of the system, use machine vision to detect a targeted feature based, at least in part, on the parameter, activate a coupler to selectively aim an emitter at the targeted feature, and activate the emitter to emit an emission toward the targeted feature while sparing non-targeted features within the operating vicinity.

### BRIEF DESCRIPTION OF THE DRAWINGS

The subject matter described herein may be understood from reading the following description of non-limiting embodiments, with reference to the attached drawings, wherein below:

FIG. 1 illustrates a portable system for capturing and communicating transportation data related to vehicles or otherwise to a transportation system according to one embodiment;

FIG. 2 illustrates a portable system according to another embodiment;

FIG. 3 illustrates another embodiment of a portable system;

FIG. 4 illustrates another embodiment of a portable system having a garment and a portable unit attached and/or attachable to the garment;

FIG. 5 illustrates another embodiment of a system having features and aspects of the invention;

FIG. 6 illustrates a control system according to one embodiment;

FIG. 7 illustrates one embodiment of a vehicle having aspects of the invention;

FIG. 8 illustrates a transportation system receiver located onboard a vehicle according to one embodiment;

FIG. 9 illustrates another embodiment of an inventive system;

FIG. 10 illustrates another embodiment of an inventive system;

FIG. 11 illustrates a perspective view of a system according to an embodiment of the invention.

FIG. 12 illustrates a side view of the system shown in FIG. 11;

FIG. 13 illustrates a top view of the system shown in FIG. 11;

FIG. 14 is a schematic illustration of an image analysis system according to one embodiment;

FIG. 15 illustrates a flowchart of one embodiment of a method for obtaining and/or analyzing image data for environmental information;

FIG. 16 is a front view of a vehicle including embodiments of the invention;

FIG. 17 is a diagram of a system for selective maintenance of way according to an embodiment of the invention;

FIG. 18 is an algorithmic flow diagram of a method for selective maintenance of way according to an embodiment of the invention; and

FIG. 19 is an algorithmic flow diagram of a method of determining a parameter and detecting a feature associated with an operating vicinity of a vehicle according to an embodiment of the invention.

### DETAILED DESCRIPTION

Embodiments described herein relate to a system for vegetation control, maintenance of way along a route, vehicular transport therefore, and associated methods. In one embodiment, a vegetation control system is provided that includes a vehicle platform for a vehicle; a dispenser that can dispense a composition onto at least a portion of an environmental feature adjacent to the vehicle; and a controller, and the controller can operate one or more of the vehicle, the vehicle platform, and the dispenser based at least in part on environmental information.

The controller may communicate with a position device that may provide location information. Location information can include position data on the vehicle, as well as the vehicle speed, data on the route over which the vehicle will travel, and various areas relating to the route. Non-vehicle information may include whether the vehicle is in a populated area, such as a city, or in the country. It may indicate whether the vehicle is on a bridge, in a draw, in a tunnel, or on a ridge. It may indicate whether the route is following along the bank of a river or an agricultural area. Additional information may include which side of the vehicle which of these features is on. The controller may actuate the dispenser based at least in part on position data obtained by the controller from the position device. During use, the controller may prevent the dispenser from spraying a spray composition while in a tunnel or near a structure. As detailed herein, the controller may control such spray factors as the duration, pressure, angle, and spray pattern in response to vegetation being higher, lower, nearer, or farther away from the vehicle.

In one embodiment, the controller includes a spray condition data acquisition unit for acquiring spray condition data for spraying a spray composition comprising an herbicide from a storage tank to a spray range defined at least in part by the environmental feature adjacent to the vehicle.

The dispenser may include a plurality of spray nozzles for spraying herbicides at different heights in the vertical direction. Optionally, the dispenser may include one or more of a variable angle spray nozzle capable of automatically adjusting the spraying angle of the spray composition. The controller can select one or more nozzles and/or adjust an aim of the selected nozzles.

Regarding environmental information, this is information that the controller may use that could affect the application of the spray composition. Suitable sensors may collect and communicate the environmental information to the controller. Environmental information may include one or more of a traveling speed of the vehicle or vehicle platform, an operating condition of the dispenser, a contents level of dispenser tanks, a type of vegetation, a quantity of vegetation, a terrain feature of a route section adjacent to the dispenser, an ambient humidity level, an ambient temperature level, a direction of travel of the vehicle, curve or grade information of the vehicle route, a direction of travel of wind adjacent to the vehicle, a windspeed of air adjacent to the vehicle, a distance of the vehicle from a determined protected location, a distance of the vehicle from the vegetation. Note that rainfall rates may be calculated by the controller in to spray composition concentration determinations. Spraying a concentrated mixture that is diluted by rainfall can achieve an intended dosage at the target foliage.

As used herein, a camera is a device for capturing and/or recording visual images. These images may be in the form of still shots, analog video signals, or digital video signals. The signals, particularly the digital video signals, may be subject to compression/decompression algorithms, such as MPEG or HEVC, for example. A suitable camera may capture and record in a determined band of wavelengths of light or energy. For example, in one embodiment the camera may sense wavelengths in the visible spectrum and in another the camera may sense wavelengths in the infrared spectrum. Multiple sensors may be combined in a single camera and may be used selectively based on the application. Further, stereoscopic and 3D cameras are contemplated for at least some embodiments described herein. These cameras may assist in determining distance, velocity, and vectors to predict (and thereby avoid) collision and damage. The term consist, or vehicle consist, refers to two or more vehicles or items of mobile equipment that are mechanically or logically coupled to each other. By logically coupled, the plural items of mobile equipment are controlled so that controls to move one of the items causes a corresponding movement in the other items in consist, such as by wireless command. An Ethernet over multiple unit (eMU) system may include, for example, a communication system for use transmitting data from one vehicle to another in consist (e.g., an Ethernet network over which data is communicated between two or more vehicles).

During use, the controller responds to the environmental information or to operator input by switching operating modes of the vehicle and/or of the dispenser. The controller may switch operating modes to selectively control one or more of activating only a subset of the dispenser nozzles. For example, if sensors or maps indicate that there is a river on one side of the vehicle at a location on the route and tall weeds in a ditch on the other side then the controller may control the dispenser to activate the nozzles on the side with the weeds but not activate on the side with the river. Further, the controller may ensure that nozzles face downward to cover the weeds that are lower than the route because they are in a ditch. That is, the dispenser may have one or more plural nozzles and these are organized into subsets, wherein the subsets may be on one or more of one side of the vehicle relative to the other, high spraying, low spraying, horizontal spraying, forward spraying, and rearward spraying. The dispenser may have adjustable nozzles that can selectively wide spray patterns and narrow streaming spray patterns. The dispenser may have one or more adjustable nozzles that can be selectively pointed in determined directions. The controller may determine, based at least in part on environmental information, that a particular type of foliage is present, a preferred spray composition component is effective (and selected by the controller), as well as whether the selected spray composition component should be applied to the leaves/stalk or to the roots/soil; and, the appropriate nozzles and pumps are activated by the controller to deliver the spray composition as determined.

In one embodiment, the controller controls a concentration of active chemicals within the composition being sprayed through the dispenser. The controller controls a mixture ratio of the composition, and the composition is a mixture of multiple active chemicals. Multiple storage tanks, with necessary pumps and tubing, allow the controller to control concentrations and mixtures of active chemicals in the spray composition. The controller can determine, in response to detection of one or more of a type of vegetation/weed; by a size of weeds; by a terrain feature what the mixture ratio and/or the concentration of active chemicals is in the spray composition.

The controller may determine a concentration, a mixture, or both of the spray composition based at least in part by a vehicle location relative to a sensitive zone. Sensitive zones can be designated, but can include populated areas, protected wetlands, and the like.

The dispenser can respond to the controller by controlling a pressure at which the spray composition is dispensed (distance and the quantity dispensed). The controller may change these parameters based at least in part on the environmental information. For example, during use, the dispenser may spray more spray composition on a side of a vehicle facing outward during traversal of the curve, and relatively less spray composition on an inward facing side during the traversal of the curve. In that way, the wayside (and its weeds) receive an equal amount of spray chemical coverage even though the relative speed of the inward and outward sides differ. Even more simply, as the vehicle moves faster, the dispenser may dispense more spray material more quickly to maintain a controlled amount of spray chemical applied to the vegetation. In one embodiment, the controller adjusts the concentration rather than the quantity of the spray composition that is applied relative to changes in speed.

In one embodiment, the dispenser can selectively add a foaming agent to the spray composition. As noted, the spray composition can be selected from a pre-mixed and ready-to-use concentration or can have a fluid reservoir (e.g., water) to which concentrated chemicals can be added in a determined dosage. In one embodiment, the dosage is static. In other embodiments, the concentration or dosage of the spray composition can be controlled by the controller. This concentration may be based in part on environmental information, vehicle speed, vegetation type, location of the vehicle relative to other vehicles, structures or people, and the like.

Suitable spray composition components may be one or more of selective herbicides, non-selective herbicides, pesticides, insecticides, fungicides, defoliants, functional fluids, and the like, and mixtures of two or more of the foregoing. Suitable herbicides may include one or more of acetochlor; acifluorfen; alachlor; ametryn; atrazine; aminopyralid; benefin; bensulfuron; bensulide; bentazon; bromacil; bromoxynil; butylate; carfentrazone; chlorimuron; chlorsulfuron; clethodim; clomazone; clopyralid; cloransulam; cycloate; desmedipham; dicamba; dichlobenil; diclofop; diclosulam; diflufenzopyr; dimethenamid; diquat; diuron; endothall; ethalfluralin; ethofumesate; fenoxaprop; fluazifop-P; flucarbazone; flufenacet; flumetsulam; flumiclorac; flumioxazin; fluometuron; fluroxypyr; fomesafen; foramsulfuron; glufosinate; glyphosate; halosulfuron; hexazinone; imazamethabenz; imazamox; imazapic; imazaquin; imazethapyr; isoxaben; isoxaflutole; lactofen; linuron; mesotrione; metolachlor-s; metribuzin; metsulfuron; molinate; napropamide; naptalam; nicosulfuron; norflurazon; oryzalin; oxadiazon; oxyfluorfen; paraquat; pelargonic acid; pendimethalin; phenmedipham; picloram; primisulfuron; prodiamine; prometryn; pronamide; propanil; prosulfuron; pyrazon; pyrithiobac; quinclorac; quizalofop; rimsulfuron; sethoxydim; siduron; simazine; sulfentrazone; sulfometuron; sulfosulfuron; tebuthiuron; terbacil; thiazopyr; thifensulfuron; thiobencarb; tralkoxydim; triallate; triasulfuron; tribenuron; triclopyr; trifluralin; and triflusulfuron. Other suitable herbicides may include “organic herbicides,” such as D-Limonene. Environmentally friendlier spray composition components can be selectively applied in environmentally sensitive areas, whereas more aggressive chemicals can be applied otherwise. Suitable functional fluids may include a foamer, a stabilizer, a wetting agent (e.g, a surfactant), a thickener, a colorant (to indicate application), and a noxious agent to discourage people and/or animals from approaching the application area. Other suitable functional fluids may include one or more of a metal corrosion inhibitor, a friction modifier or lubricant, a dust reducer, a fire retardant, and the like to achieve an affect on the route, the ballast, the ties, the rail, the wayside, and structures and items found adjacent to routes over which the vehicle may travel.

In one embodiment, the vehicle has maintenance equipment (not shown) mounted to the vehicle platform that can maintain a section of a route adjacent to the vehicle. Suitable maintenance equipment may be selected from one or more of an auger, a mower, a chainsaw or circular saw, an excavator scoop, and a winch or hoist. During use, the maintenance equipment deploys to perform work adjacent to the vehicle. The vehicle may be stopped for the action, or alternatively, may be mobile. The environmental information from the image system is used by the controller to position the maintenance equipment. Additionally, or alternatively the maintenance equipment may be used with the dispenser. The platform may dynamically shift to counter the weight of the maintenance equipment. This may reduce or eliminate tip-over of the vehicle when, for example, the excavator lifts a heavy load cantilevered and at a relatively longer distance from the platform. Environmental data allows the controller to adjust the platform, and any couplers of the maintenance equipment to the platform, to compensate for imbalances caused by the task at hand. In one embodiment, the dispenser is mounted on a controllable boom that can extend the reach of the dispenser nozzles and can aim them in directions generally not obtainable if spraying directly from the platform.

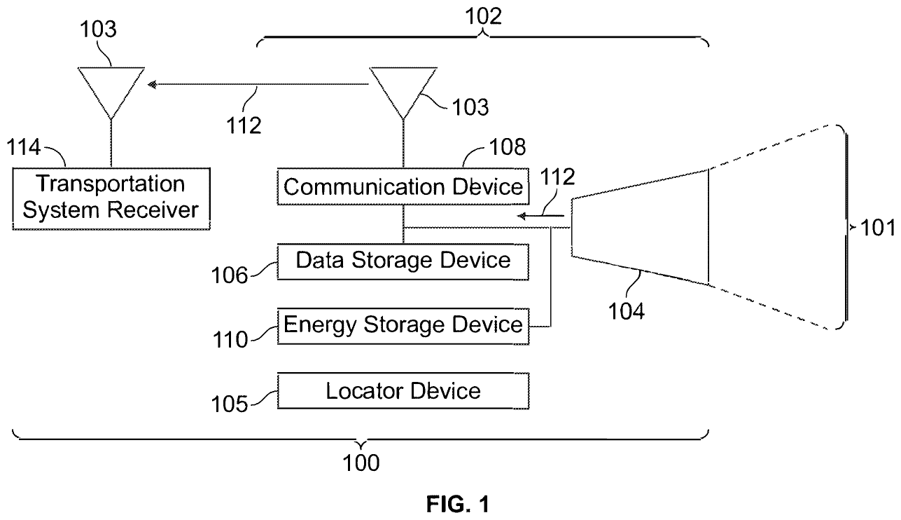

FIG. 1 illustrates a control system 100 for a vehicle (not shown in FIG. 1) that can capture and communicate data related to an environmental condition of a route over which the vehicle can travel and to determine actions to take relative to vegetation adjacent to that route, and the like according to one embodiment.

The environmental information acquisition system includes a portable unit 102 having a camera 104, a data storage device 106 and/or a communication device 108, and a battery or other energy storage device 110. The portable unit may be portable in that the portable unit is small and/or light enough to be carried by a single adult human, however there are some embodiments in which a larger unit or one that is permanently affixed to the vehicle would be suitable. The portable unit can capture and/or generate image data 112 of a field of view 101. For example, the field of view may represent a solid angle or area over which the portable unit can be exposed to the environment and thereby to generate environmental information. The image data can include still images, videos (e.g., moving images or a series of images representative of a moving object), or the like, of one or more objects within the field of view of the portable unit. In any of the embodiments of any of the systems described herein, data other than image data may be captured and communicated. For example, the portable unit may have sensors for capturing image data outside of the visible light spectrum or a microphone for capturing audio data, a vibration sensor for capturing vibration data, elevation and location data, information relating to the grade/slope, and the surrounding terrain, and so on. Terrain information can include whether there is a hill side, a ditch, or flat land adjacent to the route, whether there is a fence or a building, information about the state of the route itself (e.g., ballast and ties, painted lines, and the like), and information about the vegetation. The vegetation information can include the density of the foliage, the type of foliage, the thickness of the stalks, the distance from the route, the overhang of the route by the foliage, and the like.

A suitable portable unit may include an Internet protocol camera, such as a camera that can send video data via the Internet or another network. In one aspect, the camera can be a digital camera capable of obtaining relatively high quality image data (e.g., static, or still images and/or videos). For example, the camera may be an Internet protocol (IP) camera that generates packetized image data. A suitable camera can be a high definition (HD) camera capable of obtaining image data at relatively high resolutions.

The data storage device may be electrically connected to the portable unit and can store the image data. The data storage device may include one or more computer hard disk drives, removable drives, magnetic drives, read only memories, random access memories, flash drives or other solid state storage devices, or the like. Optionally, the data storage device may be disposed remote from the portable unit, such as by being separated from the portable unit by at least several centimeters, meters, kilometers, as determined at least in part by the application at hand.

The communication device may be electrically connected to the portable unit and can communicate (e.g., transmit, broadcast, or the like) the image data to a transportation system receiver 114 located off-board the portable unit. Optionally, the image data may be communicated to the receiver via one or more wired connections, overpower lines, through other data storage devices, or the like. The communication device and/or receiver can represent hardware circuits or circuitry, such as transceiving circuitry and associated hardware (e.g., antennas) 103, that include and/or are connected with one or more processors (e.g., microprocessors, controllers, or the like).

In one embodiment, the portable unit includes the camera, the data storage device, and the energy storage device, but not the communication device. In such an embodiment, the portable unit may be used for storing captured image data for later retrieval and use. In another embodiment, the portable unit comprises the camera, the communication device, and the energy storage device, but not the data storage device. In such an embodiment, the portable unit may be used to communicate the image data to a vehicle or other location for immediate use (e.g., being displayed on a display screen), and/or for storage remote from the portable unit (this is, for storage not within the portable unit). In another embodiment, the portable unit comprises the camera, the communication device, the data storage device, and the energy storage device. In such an embodiment, the portable unit may have multiple modes of operation, such as a first mode of operation where image data is stored within the portable unit on the data storage device 106, and a second mode of operation where the image data is transmitted off the portable unit for remote storage and/or immediate use elsewhere.

A suitable camera may be a digital video camera, such as a camera having a lens, an electronic sensor for converting light that passes through the lens into electronic signals, and a controller for converting the electronic signals output by the electronic sensor into the image data, which may be formatted according to a standard such as MP4. The data storage device, if present, may be a hard disc drive, flash memory (electronic non-volatile non-transitory computer storage medium), or the like. The communication device, if present, may be a wireless local area network (LAN) transmitter (e.g., Wi-Fi transmitter), a radio frequency (RF) transmitter that transmits in and according to one or more commercial cell frequencies/protocols (e.g., 3G or 4G), and/or an RF transmitter that can wirelessly communicate at frequencies used for vehicle communications (e.g., at a frequency compatible with a wireless receiver of a distributed power system of a rail vehicle; distributed power refers to coordinated traction control, such as throttle and braking, of a train or other rail vehicle consist having plural locomotives or other powered rail vehicle units). A suitable energy storage device may be a rechargeable lithium-ion battery, a rechargeable Ni-Mh battery, an alkaline cell, or other device suitable for portable energy storage for use in an electronic device. Another suitable energy storage device, albeit more of an energy provider than storage, include a vibration harvester and a solar panel, where energy is generated and then provided to the camera system.

The portable unit can include a locator device 105 that generates data used to determine the location of the portable unit. The locator device can represent one or more hardware circuits or circuitry that include and/or are connected with one or more processors (e.g., controllers, microprocessors, or other electronic logic-based devices). In one example, the locator device is selected from a global positioning system (GPS) receiver that determines a location of the portable unit, a beacon or other communication device that broadcasts or transmits a signal that is received by another component (e.g., the transportation system receiver) to determine how far the portable unit is from the component that receives the signal (e.g., the receiver), a radio frequency identification (RFID) tag or reader that emits and/or receives electromagnetic radiation to determine how far the portable unit is from another RFID reader or tag (e.g., the receiver), or the like. The receiver can receive signals from the locator device to determine the location of the locator device 105 relative to the receiver and/or another location (e.g., relative to a vehicle or vehicle system). Additionally, or alternatively, the locator device can receive signals from the receiver (e.g., which may include a transceiver capable of transmitting and/or broadcasting signals) to determine the location of the locator device relative to the receiver and/or another location (e.g., relative to a vehicle or vehicle system).

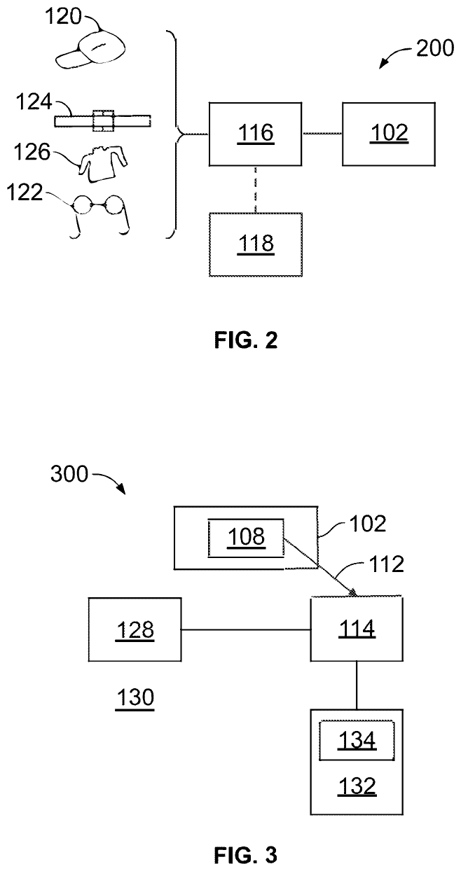

FIG. 2 illustrates an environmental information capture system 200 according to another embodiment. This system includes a garment 116 that can be worn or carried by an operator 118, such as a vehicle operator, transportation worker, or other person. A portable unit or locator device can be attached to the garment. For example, the garment may be a hat 120 (including a garment worn about the head), an ocular device 122 (e.g., a Google Glass™ device or other eyepiece), a belt or watch 124, part of a jacket 126 or other outer clothing, a clipboard, or the like. The portable unit may detachably connected to the garment, or, in other embodiments, the portable unit may be integrated into, or otherwise permanently connected to the garment. Attaching the portable unit to the garment can allow the portable unit to be worn by a human operator of a vehicle (or the human operator may be otherwise associated with a transportation system), for capturing image data associated with the human operator performing one or more functions with respect to the vehicle or transportation system more generally. The controller can determine if the operator is within a spray zone of one or more dispenser. If the operator is detected within the spray zone, the controller may block or prevent the dispenser from spraying the spray chemical through one or more of the nozzles.

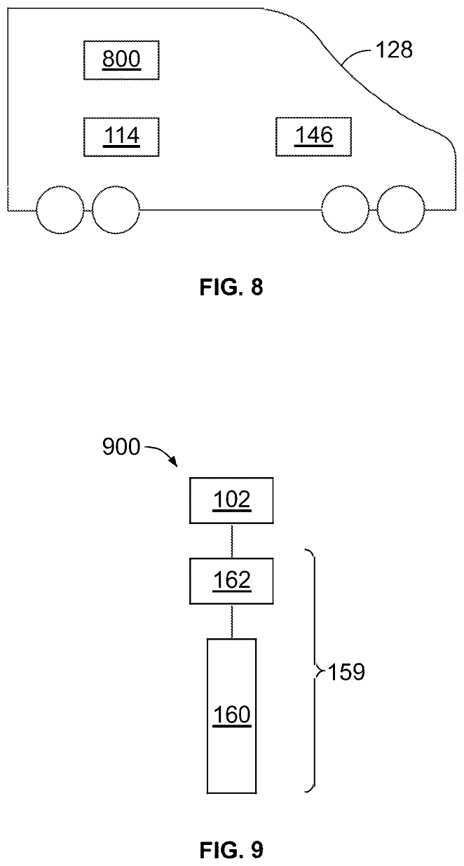

With reference to FIG. 3, in one embodiment, the portable unit may include the communication device, which can wirelessly communicate the image data to the transportation system receiver. The transportation system receiver can be located onboard a vehicle 128, at a wayside location 130 of a route of the vehicle, or otherwise remote from the vehicle. The illustrated vehicle (see also FIG. 8) is a high rail vehicle that can selectively travel on a rail track and on a roadway. Remote may refer to not being onboard the vehicle, and in embodiments, more specifically, to not within the immediate vicinity of the vehicle, such as not within a WiFi and/or cellular range of the vehicle. In one aspect, the portable unit can be fixed to the garment being worn by an operator of the vehicle and provide image data representative of areas around the operator. For example, the image data may represent the areas being viewed by the operator. The image data may no longer be generated by the portable unit during time periods that the operator is within the vehicle or within a designated distance from the vehicle. Upon exiting the vehicle or moving farther than the designated distance (e.g., five meters) from the vehicle, the portable unit may begin automatically generating and/or storing the image data. As described herein, the image data may be communicated to a display onboard the vehicle or in another location so that another operator onboard the vehicle can determine the location of the operator with the portable unit based on the image data. With respect to rail vehicles, one such instance could be an operator exiting the cab of a locomotive. If the operator is going to switch out cars from a rail vehicle that includes the locomotive, the image data obtained by the portable unit on the garment worn by the operator can be recorded and displayed to an engineer onboard the locomotive. The engineer can view the image data as a double check to ensure that the locomotive is not moved if the conductor is between cars of the rail vehicle. Once it is clear from the image data that the conductor is not in the way, then the engineer may control the locomotive to move the rail vehicle.

Optionally, the image data may be autonomously examined by one or more image data analysis systems or image analysis systems described herein. For example, one or more of the transportation receiver system 114, vehicle, and/or the portable unit may include an image data analysis system (also referred to as an image analysis system) that examines the image data for one or more purposes described herein.

Continuing, FIG. 3 illustrates a camera system 300 according to an embodiment of the invention. The system can include a display screen system 132 located remote from the portable unit and from the vehicle. The display screen system receives the image data from the transportation system receiver as a live feed and display the image data (e.g., converted back into moving images) on a display screen 134 of the display screen system. The live feed can include image data representative of objects contemporaneous with capturing the video data but for communication lags associated with communicating the image data from the portable unit to the display screen system. Such an embodiment may be used, for example, for communicating image data, captured by a human operator wearing or otherwise using the portable unit and associated with the human operator carrying out one or more tasks associated with a vehicle (e.g., vehicle inspection) or otherwise associated with a transportation network (e.g., rail track inspection), to a remote human operator viewing the display screen. A remote human operator, for example, may be an expert in the particular task or tasks, and may provide advice or instructions to the on-scene human operator based on the image data or may actuate and manipulate a dispenser system, maintenance equipment, and the vehicle itself.

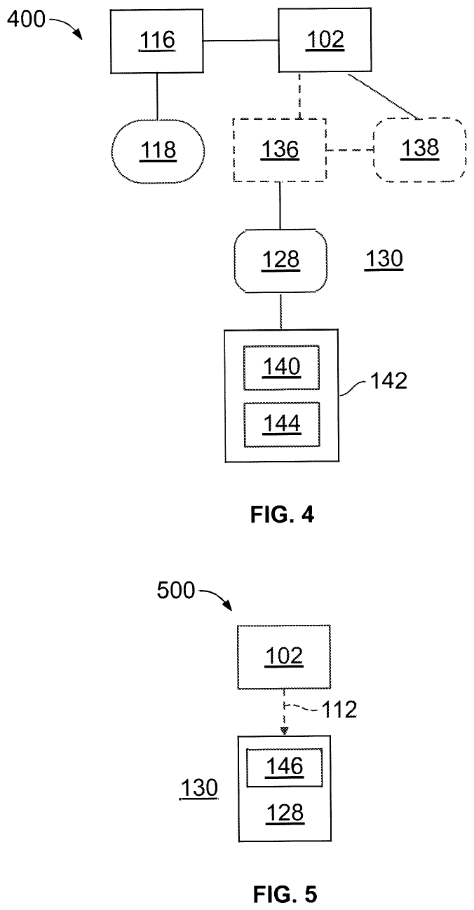

FIG. 4 illustrates another embodiment of a camera system 400 having a garment and a portable unit attached and/or attachable to the garment. The system can be similar to the other camera systems described herein, with the system further including a position detection unit 136 and a control unit 138. The position detection unit detects a position of the transportation worker wearing the garment. The configurable position detection unit may be connected to and part of the garment, connected to and part of the portable unit, or connected to and part of the vehicle or a wayside device. The position detection unit may be, for example, a global positioning system (GPS) unit, or a switch or other sensor that detects when the human operator (wearing the garment) is at a particular location in a vehicle, outside but near the vehicle, or otherwise. In one embodiment, the position detection unit can detect the presence of a wireless signal when the portable unit is within a designated range of the vehicle or vehicle cab. The position detection unit can determine that the portable unit is no longer in the vehicle or vehicle cab responsive to the wireless signal no longer being detected or a strength of the signal dropping below a designated threshold. In one embodiment, the

The control unit (which may be part of the portable unit) controls the portable unit based at least in part on the position of the transportation worker that is detected by the position detection unit. The control unit can represent hardware circuits or circuitry that include and/or are connected with one or more processors (e.g., microprocessors, controllers, or the like).

In one embodiment, the control unit controls the portable unit to a first mode of operation when the position of the transportation worker that is detected by the position detection unit indicates the transportation worker is at an operator terminal 140 of the vehicle (e.g., in a cab 142 of the vehicle), and to control the portable unit to a different, second mode of operation when the position of the transportation worker that is detected by the position detection unit indicates the transportation worker is not at the operator terminal of the vehicle. In the first mode of operation, for example, the portable unit is disabled from at least one of capturing, storing, and/or communicating the image data, and in the second mode of operation, the portable unit is enabled to capture, store, and/or communicate the image data. In such an embodiment, therefore, it may be the case that the portable unit is disabled from capturing image data when the operator is located at the operator terminal, and enabled when the operator leaves the operator terminal. The control unit can cause the camera to record the image data when the operator leaves the operator cab or operator terminal so that actions of the operator may be tracked. For example, in the context of a rail vehicle, the movements of the operator may be examined using the image data to determine if the operator is in a safe area during operation of a set of dispensers or maintenance equipment.

In another embodiment, the control unit can control the portable unit to a first mode of operation when the position of the transportation worker that is detected by the position detection unit 136 indicates the transportation worker is in an operator cab 142 of the vehicle and to control the portable unit to a different, second mode of operation when the position of the transportation worker that is detected by the position detection unit indicates the transportation worker is not in the operator cab of the vehicle. For example, the portable unit may be enabled for capturing image data when the operator is outside the operator cab, and disabled for capturing image data when the operator is inside the operator cab with no view of the environment. This may be a powered down mode to save on battery life.

In another embodiment, the system has a display screen 144 in the operator cab of the rail vehicle. The communication device of the portable unit can transmit the image data to the transportation system receiver which may be located onboard the vehicle and operably connected to the display screen, for the image data to be displayed on the display screen. Such an embodiment may be used for one operator of a vehicle to view the image data captured by another operator of the vehicle using the portable unit. For example, if the portable camera system is attached to a garment worn by the one operator when performing a task external to the vehicle, video data associated with the task may be transmitted back to the other operator remaining in the operator cab, for supervision or safety purposes.

FIG. 5 illustrates another embodiment of a camera system 500. A control system 146 onboard the vehicle may perform one or more of controlling movement of the vehicle, movement of maintenance equipment, and operation of one or more dispensers (not shown). The control system can control operations of the vehicle, such as by communicating command signals to a propulsion system of the vehicle (e.g., motors, engines, brakes, or the like) for controlling output of the propulsion system. That is, the control system can control the movement (or not) of the vehicle, as well as its speed and/or direction.

The control system can prevent movement of the vehicle responsive to a first data content of the image data and allow movement of the vehicle responsive to a different, second data content of the image data. For example, the control system onboard the vehicle may engage brakes and/or prevent motors from moving the vehicle to prevent movement of the vehicle, movement of the maintenance equipment, or operation of the dispenser responsive to the first data content of the image data indicating that the portable unit (e.g., worn by an operator, or otherwise carried by an operator) is located outside the operator cab of the vehicle and to allow movement and operation responsive to the second data content of the image data indicating that the portable unit is located inside the operator cab.

The data content of the image data can indicate that the portable unit is outside of the operator cab based on a change in one or more parameters of the image data. One of these parameters can include brightness or intensity of light in the image data. For example, during daylight hours, an increase in brightness or light intensity in the image data can indicate that the operator and the portable unit has moved from inside the cab to outside the cab. A decrease in brightness or light intensity in the image data can indicate that the operator and the portable unit has moved from outside the cab to inside the cab. Another parameter of the image data can include the presence or absence of one or more objects in the image data. For example, the control system can use one or more image and/or video processing algorithms, such as edge detection, pixel metrics, comparisons to benchmark images, object detection, gradient determination, or the like, to identify the presence or absence of one or more objects in the image data. If the object is inside the cab or vehicle, then the inability of the control system to detect the object in the image data can indicate that the operator is no longer in the cab or vehicle. But, if the object is detected in the image data, then the control system can determine that the operator is in the cab or vehicle.

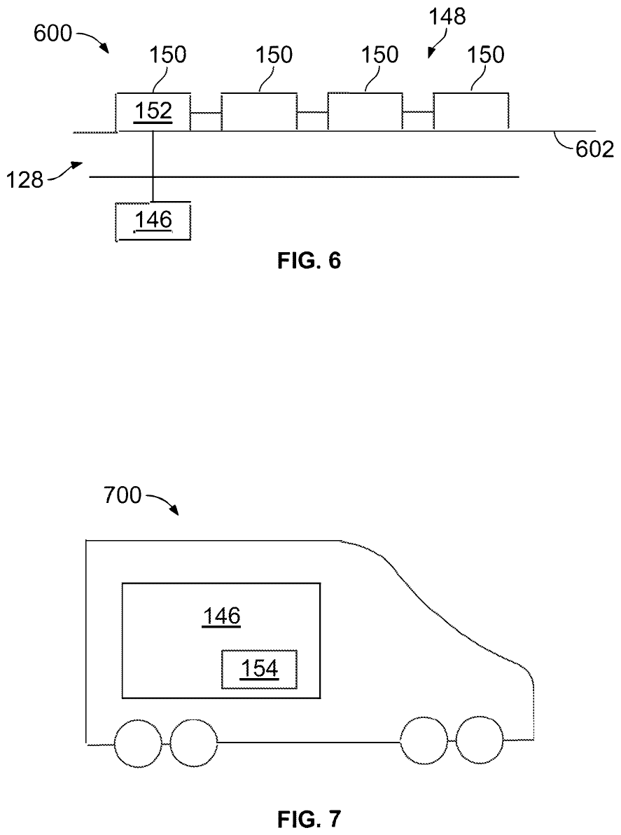

FIG. 6 illustrates one embodiment of the invention that has a vehicle consist (i.e., a group or swarm) 148 that includes plural communicatively interconnected vehicle units 150, with at least one of the plural vehicle units being a lead vehicle unit 152. The vehicle system can be a host of autonomous or semi-autonomous drones. Other suitable vehicles can be an automobile, agricultural equipment, high-rail vehicle, locomotive, marine vessel, mining vehicle, other off-highway vehicle (e.g., a vehicle that is not designed for and/or legally permitted to travel on public roadways), and the like. The consist can represent plural vehicle units communicatively connected and controlled so as to travel together along a route 602, such as a track, road, waterway, or the like. The controller may send command signals to the vehicle units to instruct the vehicle units how to move along the route to maintain speed, direction, separation distances between the vehicle units, and the like.

The control system can prevent movement of the vehicles in the consist responsive to the first data content of the environmental information indicating that the portable unit is positioned in an unsafe area (or not in a safe area) and to allow movement of the vehicles in the consist responsive to the second data content of the environmental information indicating that the portable unit is not positioned in and unsafe area (or in a known safe area). Such an embodiment may be used, for example, for preventing vehicles in a consist of moving when an operator, wearing or otherwise carrying the portable unit, is positioned in a potentially unsafe area relative to any of the vehicle units.

FIG. 7 illustrates the control system according to one embodiment. The control system 146 can be disposed onboard a high rail vehicle 700 and can include an image data analysis system 154. The illustrated vehicle is a high rail vehicle that can selectively travel on a rail track and on a roadway. The analysis system can automatically process the image data for identifying the first data content and the second data content in the image data and thereby generate environmental information. The control system may automatically prevent and allow movement of the vehicle responsive to the first data and the second data, respectively, that is identified by the image data analysis system. The image data analysis system can include one or more image analysis processors that autonomously examine the image data obtained by the portable unit for one or more purposes, as described herein.

FIG. 8 illustrates the transportation system receiver located onboard the vehicle according to one embodiment. The transportation system receiver can wirelessly communicate network data onboard and/or off-board the vehicle, and/or to automatically switch to a mode for receiving the environmental information from the portable unit responsive to the portable unit being active to communicate the environmental information. For example, responsive to the portable unit being active to transmit the environmental information, the transportation system receiver may switch from a network wireless client mode of operation 156 (transmitting data originating from a device onboard the vehicle, such as the control unit) to the mode for receiving the environmental information from the portable unit. The mode for receiving the environmental information from the portable unit may include a wireless access point mode of operation 158 (receiving data from the portable unit).

In another embodiment, the portable unit may include the transportation system receiver located onboard the vehicle. The transportation system receiver can wirelessly communicate network data onboard and/or off-board the vehicle, and/or to automatically switch from a network wireless client mode of operation to a wireless access point mode of operation, for receiving the environmental information from the portable unit. This network data can include data other than environmental information. For example, the network data can include information about an upcoming trip of the vehicle (e.g., a schedule, grades of a route, curvature of a route, speed limits, areas under maintenance or repair, etc.), cargo being carried by the vehicle, or other information.

Alternatively, the network data can include the image data. The receiver can switch modes of operation and receive the environmental information responsive to at least one designated condition of the portable unit. For example, the designated condition may be the potable portable unit being operative to transmit the environmental information, or the portable unit being in a designated location. As another example, the designated condition may be movement or the lack of movement of the portable unit. Responsive to the receiver and/or portable unit determining that the portable unit has not moved and/or has not moved into or out of the vehicle, the portable unit may stop generating the environmental information, the portable unit may stop communicating the environmental information to the receiver, and/or the receiver may stop receiving the environmental information from the portable unit. Responsive to the receiver and/or portable unit determining that the portable unit is moving and/or has moved into or out of the vehicle, the portable unit may begin generating the environmental information, the portable unit may begin communicating the environmental information to the receiver, and/or the receiver may begin receiving the environmental information from the portable unit.

In another embodiment of one or more of the systems described herein, the system is configured so that the image data/environmental information can be stored and/or used locally (e.g., in the vehicle), or to be transmitted to a remote location (e.g., off-vehicle location) based on where the vehicle is located. For example, if the vehicle is in a yard (e.g., a switching yard, maintenance facility, or the like), the environmental information may be transmitted to a location in the yard. But, prior to the vehicle entering the yard or a designated location in the yard, the environmental information may be stored onboard the vehicle and not communicated to any location off of the vehicle.

Thus, in an embodiment, the system further comprises a control unit that, responsive to at least one of a location of the portable unit or a control input, controls at least one of the portable unit or the transportation system receiver to a first mode of operation for at least one of storing or displaying the video data on board the rail vehicle and to a second mode of operation for communicating the video data off board the rail vehicle for at least one of storage or display of the video data off board the rail vehicle. For example, the control unit may control at least one of the portable unit or the transportation system receiver from the first mode of operation to the second mode of operation responsive to the location of the portable unit being indicative of the rail vehicle being in a city or populated area.

During operation of the vehicle and/or portable unit outside of a designated area (e.g., a geofence extending around a vehicle yard or other location), the image data generated by the camera may be locally stored in the data storage device of the portable unit, shown on a display of the vehicle, or the like. Responsive to the vehicle and/or portable unit entering into the designated area, the portable unit can switch modes to begin wirelessly communicating the image data to the receiver, which may be located in the designated area. Changing where the image data is communicated based on the location of the vehicle and/or portable unit can allow for the image data to be accessible to those operators viewing the image data for safety, analysis, or the like. For example, during movement of the vehicle outside of the vehicle yard, the image data can be presented to an onboard operator, and/or the image data may be analyzed by an onboard analysis system of the vehicle to generate environmental information and ensure safe operation of the vehicle. Responsive to the vehicle and/or portable unit entering into the vehicle yard, the image data and/or environmental information can be communicated to a central office or management facility for remote monitoring of the vehicle and/or operations being performed near the vehicle.

As one example, event data transmission (e.g., the transmitting, broadcasting, or other communication of image data) may occur based on various vehicle conditions, geographic locations, and/or situations. The image data and/or environmental information may be either pulled (e.g., requested) or pushed (e.g., transmitted and/or broadcast) from the vehicle. For example, image data can be sent from a vehicle to an off-board location based on selected operating conditions (e.g., emergency brake application), a geographic location (e.g., in the vicinity of a crossing between two or more routes), selected and/or derived operating areas of concern (e.g., high wheel slip or vehicle speed exceeding area limits), and/or time driven messages (e.g., sent once a day). The off-board location may request and retrieve the image data from specific vehicles on demand.

FIG. 9 illustrates another embodiment of a camera system 900. The system includes a portable support 159 having at least one leg 160 and a head 162 attached to the at least one leg. The head detachably couples to the portable unit, and the at least one leg autonomously supports (e.g., without human interaction) the portable unit at a wayside location off-board the vehicle. The support can be used to place the portable unit in a position to view at least one of the vehicle and/or the wayside location. The communication device can wirelessly communicate the image data to the transportation system receiver that is located onboard the vehicle. The image data can be communicated from off-board the vehicle to onboard the vehicle for at least one of storage and/or display of the image data onboard the vehicle. In one example, the portable support may be a camera tripod. The portable support may be used by an operator to set up the portable unit external to the vehicle, for transmitting the image data back to the vehicle for viewing in an operator cab of the vehicle or in another location. The image data can be communicated to onboard the vehicle to allow the operator and/or another passenger of the vehicle to examine the exterior of the vehicle, to examine the wayside device and/or location, to examine the route on which the vehicle is traveling, or the like. In one example, the image data may be communicated onboard the vehicle from an off-board location to permit the operator and/or passengers to view the image data for entertainment purposes, such as to view films, videos, or the like.

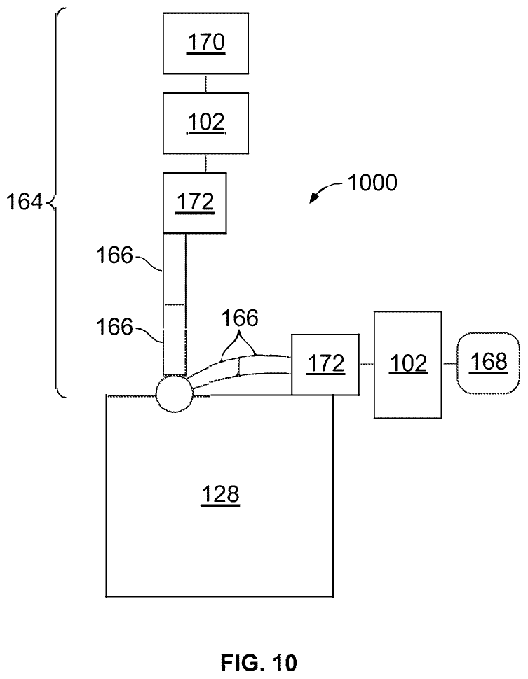

FIG. 10 illustrates an embodiment of a spray system 1000. The system includes a controllable mast 164 that can be attached to a platform of the vehicle. The retractable mast has one or more mast segments 166 that support a maintenance equipment implement 168 and a dispenser 170 relative to the vehicle. The mast includes a coupler 172 attached to at least one of the mast segments. The coupler allows for controlled movement and deployment of the maintenance equipment and/or the dispenser. A portable unit 102 can be coupled to the retractable mast.

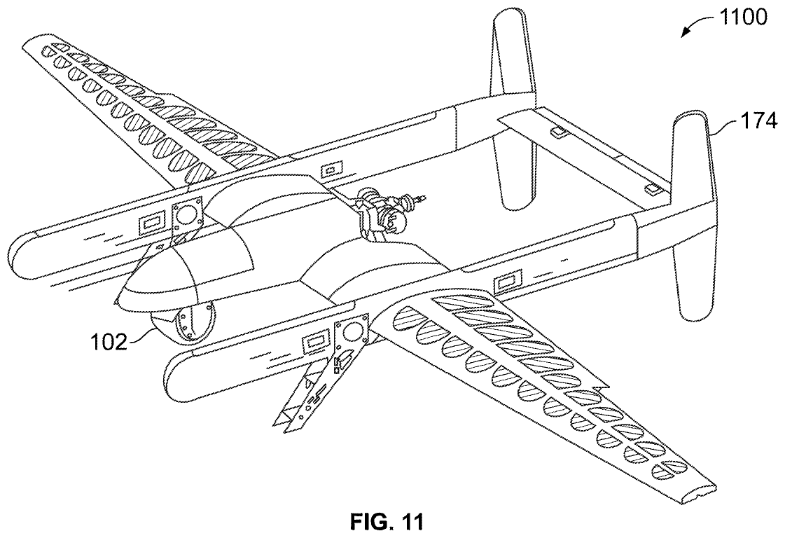

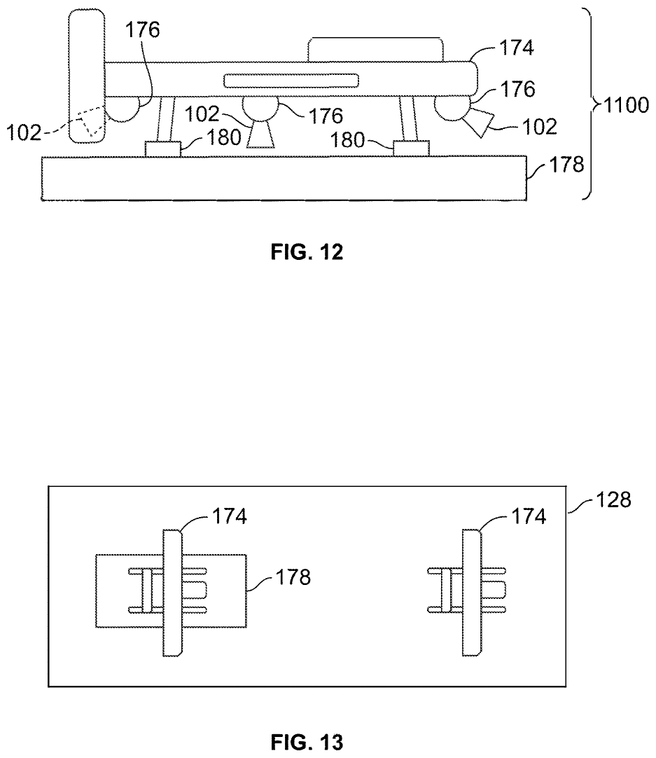

FIGS. 11, 12, and 13 illustrate an embodiment of an environmental information acquisition system 1100. FIG. 11 illustrates a perspective view of the system, FIG. 12 illustrates a side view of the system, and FIG. 13 illustrates a top view of the system 1100. The system includes an aerial device 174 that can navigate via one of remote control or autonomous operation while flying over a route of the ground vehicle. The aerial device may have one or more docks 176 for receiving one or more portable units and may have a vehicle dock for coupling the aerial device to the vehicle. In the illustrated example, the aerial device includes three cameras, with one portable unit facing along a forward direction of travel 1200 of the aerial device, another portable unit facing along a downward direction 1202 toward the ground or route over which the aerial device flies, and another portable unit facing along a rearward direction 1204 of the aerial device. Alternatively, a different number of portable units may be used and/or the portable units may be oriented in other directions.

When the aerial device is in the air, the portable units can be positioned for the cameras to view the route, the vehicle, or other areas near the vehicle. The aerial device may be, for example, a scale dirigible, a scale helicopter, an aircraft, or the like. By “scale” it means that the aerial device may be smaller than needed for transporting humans, such as 1/10 scale or smaller of a human transporting vehicle. A suitable scale helicopter can include multi-copters and the like.

The system can include an aerial device vehicle dock 178 to attach the aerial device to the vehicle. The aerial device vehicle dock can receive the aerial device for at least one of detachable coupling of the aerial device to the vehicle, charging of a battery of the aerial device from a power source of the vehicle, or the like. For example, the dock can include one or more connectors 180 that mechanically or magnetically coupled with the aerial device to prevent the aerial device from moving relative to the dock, that conductively couple an onboard power source (e.g., battery) of the aerial device with a power source of the vehicle (e.g., generator, alternator, battery, pantograph, or the like) so that the power source of the aerial device can be charged by the power source of the vehicle during movement of the vehicle.

The aerial device can fly off of the vehicle to obtain image data that is communicated from one or more of the cameras onboard the aerial device to one or more receivers 114 onboard the vehicle and converted to environmental information. The aerial device can fly relative to the vehicle while the vehicle is stationary and/or while the vehicle is moving along a route. The environmental information may be displayed to an operator on a display device onboard the vehicle and/or may be autonomously examined as described herein by the controller that may operate the vehicle, the maintenance equipment, and/or the dispenser. When the aerial device is coupled into the vehicle dock, one or more cameras can be positioned to view the route during movement of the vehicle.

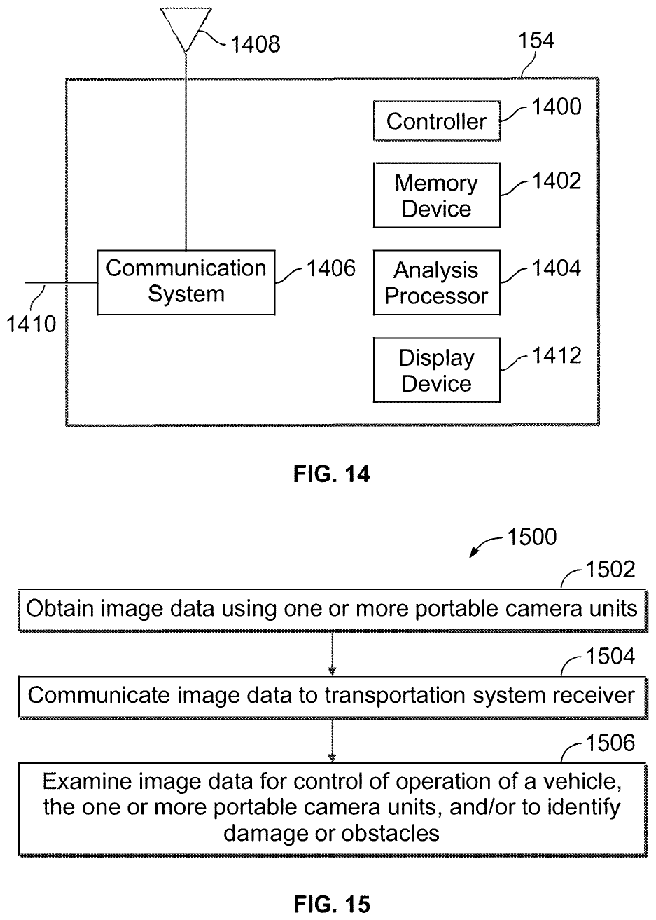

FIG. 14 is a schematic illustration of the image analysis system 154 according to one embodiment. As described herein, the image analysis system can be used to examine the data content of the image data to automatically identify objects in the image data, aspects of the environment (such as foliage), and the like. A controller 1400 of the system includes or represents hardware circuits or circuitry that includes and/or is connected with one or more computer processors, such as one or more computer microprocessors. The controller can save image data obtained by the portable unit to one or more memory devices 1402 of the imaging system, generate alarm signals responsive to identifying one or more problems with the route and/or the wayside devices based on the image data that is obtained, or the like. The memory device 1402 includes one or more computer readable media used to at least temporarily store the image data. A suitable memory device can include a computer hard drive, flash or solid state drive, optical disk, or the like.

Additionally, or alternatively, the image data and/or environmental information may be used to inspect the health of the route, status of wayside devices along the route being traveled on by the vehicle, or the like. The field of view of the portable unit can encompass at least some of the route and/or wayside devices disposed ahead of the vehicle along a direction of travel of the vehicle. During movement of the vehicle along the route, the portable unit can obtain image data representative of the route and/or the wayside devices for examination to determine if the route and/or wayside devices are functioning properly, or have been damaged, need repair or maintenance, need application of the spray composition, and/or need further examination or action.

The image data created by the portable unit can be referred to as machine vision, as the image data represents what is seen by the system in the field of view of the portable unit. One or more analysis processors 1404 of the system may examine the image data to identify conditions of the vehicle, the route, and/or wayside devices and generate the environmental information. Optionally, the analysis processor can examine the terrain at, near, or surrounding the route and/or wayside devices to determine if the terrain has changed such that maintenance of the route, wayside devices, and/or terrain is needed. For example, the analysis processor can examine the image data to determine if vegetation (e.g., trees, vines, bushes, and the like) is growing over the route or a wayside device (such as a signal) such that travel over the route may be impeded and/or view of the wayside device may be obscured from an operator of the vehicle. As another example, the analysis processor can examine the image data to determine if the terrain has eroded away from, onto, or toward the route and/or wayside device such that the eroded terrain is interfering with travel over the route, is interfering with operations of the wayside device, or poses a risk of interfering with operation of the route and/or wayside device. Thus, the terrain “near” the route and/or wayside device may include the terrain that is within the field of view of the portable unit when the route and/or wayside device is within the field of view of the portable unit, the terrain that encroaches onto or is disposed beneath the route and/or wayside device, and/or the terrain that is within a designated distance from the route and/or wayside device (e.g., two meters, five meters, ten meters, or another distance). The analysis processor can represent hardware circuits and/or circuitry that include and/or are connected with one or more processors, such as one or more computer microprocessors, controllers, or the like.

Acquisition of image data from the portable unit can allow for the analysis processor 1404 to have access to sufficient information to examine individual video frames, individual still images, several video frames, or the like, and determine the condition of the wayside devices and/or terrain at or near the wayside device. The image data optionally can allow for the analysis processor to have access to sufficient information to examine individual video frames, individual still images, several video frames, or the like, and determine the condition of the route. The condition of the route can represent the health of the route, such as a state of damage to one or more rails of a track, the presence of foreign objects on the route, overgrowth of vegetation onto the route, and the like. As used herein, the term “damage” can include physical damage to the route (e.g., a break in the route, pitting of the route, or the like), movement of the route from a prior or designated location, growth of vegetation toward and/or onto the route, deterioration in the supporting material (e.g., ballast material) beneath the route, or the like. For example, the analysis processor may examine the image data to determine if one or more rails are bent, twisted, broken, or otherwise damaged. Optionally, the analysis processor can measure distances between the rails to determine if the spacing between the rails differs from a designated distance (e.g., a gauge or other measurement of the route). The analysis of the image data by the analysis processor can be performed using one or more image and/or video processing algorithms, such as edge detection, pixel metrics, comparisons to benchmark images, object detection, gradient determination, or the like.

A communication system 1406 of the system represents hardware circuits or circuitry that include and/or are connected with one or more processors (e.g., microprocessors, controllers, or the like) and communication devices (e.g., wireless antenna 1408 and/or wired connections 1410) that operate as transmitters and/or transceivers for communicating signals with one or more locations. For example, the communication system may wirelessly communicate signals via the antenna and/or communicate the signals over the wired connection (e.g., a cable, bus, or wire such as a multiple unit cable, train line, or the like) to a facility and/or another vehicle system, or the like.

The image analysis system optionally may examine the image data obtained by the portable unit to identify features of interest and/or designated objects in the image data. By way of example, the features of interest can include gauge distances between two or more portions of the route. With respect to rail vehicles, the features of interest that are identified from the image data can include gauge distances between rails of the route. The designated objects can include wayside assets, such as safety equipment, signs, signals, switches, inspection equipment, or the like. The image data can be inspected automatically by the route examination systems to determine changes in the features of interest, designated objects that are missing, designated objects that are damaged or malfunctioning, and/or to determine locations of the designated objects. This automatic inspection may be performed without operator intervention. Alternatively, the automatic inspection may be performed with the aid and/or at the request of an operator.

The image analysis system can use analysis of the image data to detect damage to the route. For example, misalignment of track traveled by rail vehicles can be identified. Based on the detected misalignment, an operator of the vehicle can be alerted so that the operator can implement one or more responsive actions, such as by slowing down and/or stopping the vehicle. When the damaged section of the route is identified, one or more other responsive actions may be initiated. For example, a warning signal may be communicated (e.g., transmitted or broadcast) to one or more other vehicles to warn the other vehicles of the damage, a warning signal may be communicated to one or more wayside devices disposed at or near the route so that the wayside devices can communicate the warning signals to one or more other vehicles, a warning signal can be communicated to an off-board facility that can arrange for the repair and/or further examination of the damaged segment of the route, or the like.

In another embodiment, the image analysis system can examine the image data to identify text, signs, or the like, along the route. For example, information printed or displayed on signs, display devices, vehicles, or the like, indicating speed limits, locations, warnings, upcoming obstacles, identities of vehicles, or the like, may be autonomously read by the image analysis system. The image analysis system can identify information by the detection and reading of information on signs. In one aspect, the image analysis processor can detect information (e.g., text, images, or the like) based on intensities of pixels in the image data, based on wireframe model data generated based on the image data, or the like. The image analysis processor can identify the information and store the information in the memory device. The image analysis processor can examine the information, such as by using optical character recognition to identify the letters, numbers, symbols, or the like, which are included in the image data. This information may be used to autonomously and/or remotely control the vehicle, such as by communicating a warning signal to the control unit of a vehicle, which can slow the vehicle in response to reading a sign that indicates a speed limit that is slower than a current actual speed of the vehicle. As another example, this information may be used to identify the vehicle and/or cargo carried by the vehicle by reading the information printed or displayed on the vehicle.

In another example, the image analysis system can examine the image data to ensure that safety equipment on the route is functioning as intended or designed. For example, the image analysis processor, can analyze image data that shows crossing equipment. The image analysis processor can examine this data to determine if the crossing equipment is functioning to notify other vehicles at a crossing (e.g., an intersection between the route and another route, such as a road for automobiles) of the passage of the vehicle through the crossing.

In another example, the image analysis system can examine the image data to predict when repair or maintenance of one or more objects shown in the image data is needed. For example, a history of the image data can be inspected to determine if the object exhibits a pattern of degradation over time. Based on this pattern, a services team (e.g., a group of one or more personnel and/or equipment) can identify which portions of the object are trending toward a bad condition or already are in bad condition, and then may proactively perform repair and/or maintenance on those portions of the object. The image data from multiple different portable units acquired at different times of the same objects can be examined to determine changes in the condition of the object. The image data obtained at different times of the same object can be examined in order to filter out external factors or conditions, such as the impact of precipitation (e.g., rain, snow, ice, or the like) on the appearance of the object, from examination of the object. This can be performed by converting the image data into wireframe model data, for example.

FIG. 15 illustrates a flowchart of one embodiment of a method 1500 for obtaining and/or analyzing image data for transportation data communication. The method may be practiced by one or more embodiments of the systems described herein. At 1502, image data is obtained using one or more portable units. As described above, the portable units may be coupled to a garment worn by an operator onboard and/or off-board a vehicle, may be coupled to a wayside device that is separate and disposed off-board the vehicle but that can obtain image data of the vehicle and/or areas around the vehicle, may be coupled to the vehicle, may be coupled with an aerial device for flying around and/or ahead of the vehicle, or the like. In one aspect, the portable unit may be in an operational state or mode in which image data is not being generated by the portable unit during time periods that the portable unit is inside of (or outside of) a designated area, such as a vehicle. Responsive to the portable unit moving outside of (or into) the designated area, the portable unit may change to another operational state or mode to begin generating the image data.

At 1504, the image data is communicated to the transportation system receiver. For example, the image data can be wirelessly communicated from the portable unit to the transportation system receiver. Optionally, the image data can be communicated using one or more wired connections. The image data can be communicated as the image data is obtained, or may be communicated responsive to the vehicle and/or the portable unit entering into or leaving a designated area, such as a geo-fence.

At 1506, the image data is examined for one or more purposes, such as to control or limit control of the vehicle, to control operation of the portable unit, to identify damage to the vehicle, the route ahead of the vehicle, or the like, and/or to identify obstacles in the route such as encroaching foliage. For example, if the portable unit is worn on a garment of an operator that is off-board the vehicle, then the image data can be analyzed to determine whether the operator is between two or more vehicle units of the vehicle and/or is otherwise in a location where movement of the vehicle would be unsafe (e.g., the operator is behind and/or in front of the vehicle). With respect to vehicle consists, the image data can be examined to determine if the operator is between two or more vehicle units or is otherwise in a location that cannot easily be seen (and is at risk of being hurt or killed if the vehicle consist moves). Optionally, the image data can be examined to determine if the off-board operator is in a blind spot of the on-board operator of the vehicle, such as behind the vehicle.

An image analysis system described above can examine the image data and, if it is determined that the off-board operator is between vehicle units, is behind the vehicle, and/or is otherwise in a location that is unsafe if the vehicle moves, then the image analysis system can generate a warning signal that is communicated to the control unit of the vehicle. This warning signal can be received by the control unit and, responsive to receipt of this control signal, the control unit can prevent movement of the vehicle. For example, the control unit may disregard movement of controls by an onboard operator to move the vehicle, the control unit may engage brakes and/or disengage a propulsion system of the vehicle (e.g., turn off or otherwise deactivate an engine, motor, or other propulsion-generating component of the vehicle). In one aspect, the image analysis system can examine the image data to determine if the route is damaged (e.g., the rails on which a vehicle is traveling are broken, bent, or otherwise damaged), if obstacles are on the route ahead of the vehicle (e.g., another vehicle or object on the route), or the like.

In one embodiment, the environmental information acquisition system data may be communicated via the controller to an offboard back-office system, where various operational and environmental information may be collected, stored and analyzed. In one back-office system, archival or historic information is collected from at least one vehicle having an environmental information acquisition system. The system can store information regarding one or more of the location of spraying, the type and/or concentration of spray composition, the quantity of spray compensation dispensed, the vehicle speed during the spray event, the environmental data (ditch, hill, curve, straightaway, etc.), the weather at the time of application (rain, cloud cover, humidity, temperature), the time of day and time of season during the spray event, and the like. Further, the system may store information regarding the type of vegetation and other related data as disclosed herein.

With the data collected by the controller, the back-office system may determine an effectiveness over time of a particular treatment regime. For example, the back-office system may note whether subsequent applications of spray composition are excessive (e.g., the weeds in a location are still brown and dead from the last treatment) or insufficient (e.g., the weeds in a location are overgrown relative to the last evaluation by an environmental information acquisition system on a vehicle according to an embodiment of the invention). Further, the back-office system can adjust or change the spray composition suggestions to try different concentrations, different chemical components, different spray application techniques to achieve a desired outcome of foliage control.

State and local regulations regarding the use of certain chemicals may differ from location to location. In another embodiment, location of the vehicle at the time of the spray event may be controlled to comply with relevant state or regional regulations in effect at that location. In one operating mode, the controller selects a spray composition (including component types and concentrations) that is the most effective in view of the environmental information but is still compliant with the state and/or local regulations (and as such perhaps not the most effective of all the possible component types and concentrations available for the controller to select from).

In one embodiment, a system (e.g., an environmental information acquisition system) includes a portable unit and a garment. The portable unit includes a camera that an capture at least image data, at least one of a data storage device electrically connected to the camera and can store the image data or a communication device electrically connected to the camera and can wirelessly communicate the image data to a transportation system receiver located off-board the portable unit. The garment can be worn by a transportation worker. The portable unit can be attached to the garment. In one aspect, the garment includes one or more of a hat/helmet, a badge, a smart phone, an electronic watch, or an ocular device. In one aspect, the system can include a locator device that can detect a location of the transportation worker wearing the garment, and a control unit that can control the portable unit based at least in part on the location of the transportation worker that is detected by the locator device. In one aspect, the control unit can control the portable unit to a first mode of operation responsive to the location of the transportation worker that is detected by the locator device indicating that the transportation worker is at an operator terminal of the vehicle and to control the portable unit to a different, second mode of operation responsive to the location of the transportation worker that is detected by the locator device indicating that the transportation worker is not at the operator terminal of the vehicle.

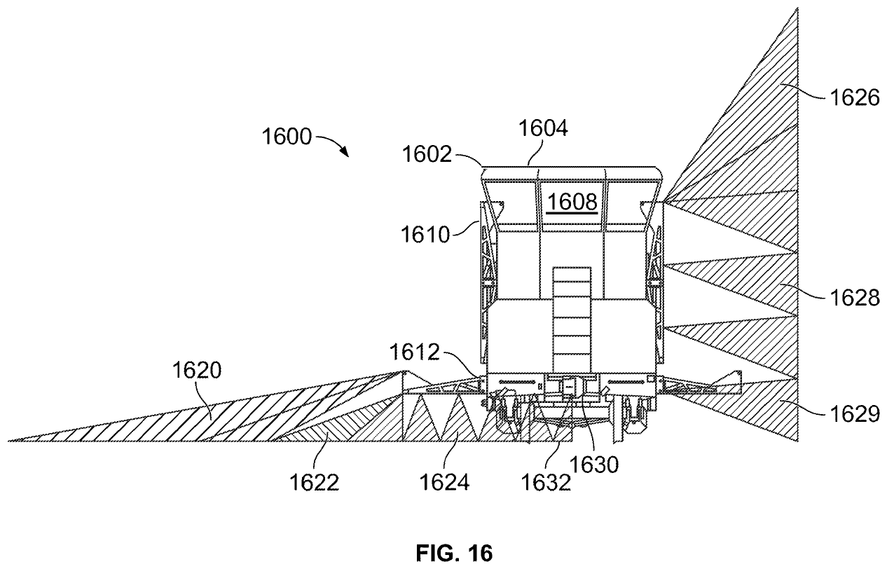

With reference to FIG. 16, a vehicle system 1600 having an embodiment of the invention is show. The vehicle system includes a control cab 1602. The control cab includes a roof 1604 over an operator observation deck (not shown) and a plurality of windows 1608. The windows may be oriented at an angle to allow an improved field of view of an operator on the observation deck in viewing areas of the terrain proximate to the control cab. An extendable boom 1610 is one of a plurality of booms (shown in an upright or tight configuration). An extendable boom 1612 is one of the plurality of booms (shown in an extended or open configuration). The booms may be provided in sets, with each set having plural booms and being located on a side of the vehicle system. The booms, and the sets, may be operated independently of each other, or in a manner that coordinates their action depending on the selected operating mode. Supported by the boom, a plurality of nozzles may provide spray patterns extending from the booms. The location and type of nozzle may produce, for example, and in an extended position, a distal spray pattern 1620, a medial spray pattern 1622, and a proximate spray pattern 1624. While in an upright configuration, the nozzles may produce a relatively high spray pattern 1626, an average height spray pattern 1628, and a low spray pattern 1629. A front rigging 1630 may produce spray patterns 1632 that cover the area in the front (or alternatively in the rear) of the control cab.

The control cab, and its observation deck, may have a self-contained air system and/or or a filter system. This system may prevent operators on the observation deck from contacting or breathing any of the spray composition that is being sprayed. The chemical concentrates onboard the control cab may be sealed separate from the operators. In one embodiment, the spray composition compounds may be concentrated liquids. In one embodiment, the spray composition compounds may be a dry solid. The dry solid may be mixed and/or dissolved in water prior to being sprayed.

During use, as noted herein, the nozzles can be selectively activated. The activation can be accomplished automatically in some embodiments, and manually by an operator in other embodiments. The operator may be located in the observation deck in one embodiment, or may be remote from the vehicle in other embodiments. In addition to the nozzle activation being selective, the application of the spray composition can be controlled by extending or retracting the booms. The booms may be partially extended in some embodiments. The volume and pressure of the spray composition can be controlled through the nozzles. And the concentration and type of active component in the spray composition can be controlled.

In one embodiment, a water storage tank may be coupled to the control cab. The tank may be both mechanically coupled and fluidically coupled. Multiple water tanks may be added via coupling to the vehicle system. The water level for any water storage tank onboard and fluidically coupled may be monitored by the controller. In one embodiment, the active chemical compositions are stored in the control cab, and water is pumped from the water storage tank to the control cab for mixing and dilution prior to spraying.

The water storage tank may include an energy storage device. Suitable energy storage devices may include batteries, fuel cells, and auxiliary generators (alone or in combination). The aux generator may, for example, generate power to operate a pump that supplies water from the water storage tank through a flexible fluidic coupling to the control cab. The water may be supplied on demand. In one embodiment, the water storage tank simply maintains pressure in the line by operating the pump in response to a pressure drop. Decoupling the hose connecting the vehicle platforms may activate a valve to prevent loss of the water. Check valves may operate to prevent backflow of water. The water storage tank may include a plurality of individual holding cells. Suitable cells may be formed of thermoplastic. These cells may be fluidically couple in series. The cells may reduce or prevent sloshing of the water while the water storage tank is in motion or is on a grade.

In one aspect, the vehicle control unit can include an image data analysis system can automatically process the image data for identifying the first data content and the second data content. The vehicle control unit can automatically prevent and allow action by the vehicle responsive to the first data and the second data, respectively, that is identified by the image data analysis system. In one aspect, the system includes the transportation system receiver that can be located onboard the vehicle, where the transportation system receiver can communicate network data other than the image data at least one of onboard or off-board the vehicle and to automatically switch to a mode for receiving the image data from the portable unit responsive to the portable unit being active to communicate the image data. In one aspect, the system includes a retractable mast configured for attachment to a vehicle. The retractable mast can include one or more mast segments deployable from a first position relative to the vehicle to a second position relative to the vehicle. The second position is higher than the first position. The mast can include a coupler attached to one of the one or more mast segments for detachable coupling of the portable unit to said one of the one or more mast segments. The portable unit is coupled to the retractable mast by way of the coupler and the retractable mast is deployed to the second position, with the portable unit positioned above the vehicle.

In one embodiment, the vehicle is a marine vessel (not shown) and the portable system identifies marine equivalents to foliage. That is, a vessel may detect algal blooms, seaweed beds, oil slicks, and plastic debris, for example. The spray composition may be an algicide (for algal blooms), a water tolerant and non-persistent herbicide (for unwanted seaweed), oil-digesting microbials (for oil slicks), and the like. Other suitable spray compositions may include flocculants, agglomerates, precipitants, pH adjusters and/or buffers, defoamers, dispersants, and the like.

In one embodiment, a vehicle system with spray control is provided. The vehicle system includes a vehicle platform for a vehicle, a dispenser configured to dispense a composition onto at least a portion of an environmental feature adjacent to the vehicle, and a controller configured to operate one or more of the vehicle, the vehicle platform, or the dispenser based at least in part on environmental information.

Optionally, the controller is configured to communicate with a position device and to actuate the dispenser based at least in part on position data obtained by the controller from the position device. The controller may include a spray condition data acquisition unit for acquiring spray condition data for spraying the composition comprising an herbicide from a storage tank to a spray range defined at least in part by the environmental feature adjacent to the vehicle. The dispenser may include a plurality of spray nozzles for spraying herbicides at different heights in a vertical direction.

The dispenser may include a variable angle spray nozzle capable of automatically adjusting a spraying angle of the composition. The environmental information may include one or more of a traveling speed of the vehicle or the vehicle platform, an operating condition of the dispenser, a contents level of dispenser tanks, a type of vegetation, a quantity of the vegetation, a terrain feature of a route section adjacent to the dispenser, an ambient humidity level, an ambient temperature level, a direction of travel of the vehicle, curve or grade information of a vehicle route, a direction of travel of wind adjacent to the vehicle, a windspeed of air adjacent to the vehicle, a distance of the vehicle from a determined protected location, and/or a distance of the vehicle from the vegetation.

The dispenser may include plural dispenser nozzles through which the composition is sprayed, and the controller can be configured to respond to the environmental information by switching operating modes with different ones of the operating modes selectively activating different nozzles of the dispenser nozzles. The dispenser can include plural dispenser nozzles organized into subsets. The subsets may be configured as one or more of: spraying one side of the vehicle, high spraying, low spraying, horizontal spraying, forward spraying, or rearward spraying. The dispenser can have adjustable nozzles that are configured to have selectively wide spray patterns and narrow streaming spray patterns.

The dispenser can have adjustable nozzles that are configured to be selectively pointed in determined directions. The controller can control a concentration of active chemicals within the composition being sprayed through the dispenser. The composition may be a mixture of multiple active chemicals, and the controller can be configured to control a mixture ratio of the multiple active chemicals. The controller may be configured to determine one or more of the mixture ratio or a concentration of the active chemicals in the composition in response to detection of one or more of a type of vegetation, a type of weed, a size of the weed, or a terrain feature.

The controller can be configured to selectively determine a concentration, a mixture, or both the concentration and the mixture of the composition based at least in part on a vehicle location relative to a sensitive zone. The dispenser can be configured to selectively add a foaming agent to the composition. The controller can be configured to control a pressure at which the dispenser dispenses the composition. The controller may be configured to select one or more nozzles of the dispenser or adjust an aim of the one or more nozzles.

The vehicle may be a high rail vehicle configured to selectively travel on a rail track and on a roadway. The vehicle can have maintenance equipment be mounted to the vehicle platform and configured to maintain a section of a route adjacent to the vehicle. The maintenance equipment can include one or more of an auger, a mower, a chainsaw or circular saw, an excavator scoop, a winch, and/or a hoist. The controller can communicate with sensors that determine a nature of vegetation adjacent to the route. The controller can communicate with sensors that determine whether a person is within a spray zone of the spray composition and to block the dispenser from spraying responsive to detecting a person within the spray zone. The controller can communicate with sensors that determine whether a person is within an area where operation of maintenance equipment mounted to the platform would injury the person.

In one embodiment, a method includes dispensing a composition onto at least a portion of an environmental feature adjacent to a vehicle having a vehicle platform. The composition is dispensed from a dispenser. The method also includes operating one or more of the vehicle, the vehicle platform, and/or the dispenser using a controller and based at least in part on environmental information.

In one embodiment, a system includes a dispenser configured to be disposed onboard a vehicle. The dispenser is configured to spray a chemical composition onto at least a portion of an environmental feature adjacent to the vehicle. The system also includes a controller configured to operate one or more of the vehicle or the dispenser based at least in part on the environmental feature.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

The above description is illustrative and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Other embodiments may be apparent to one of ordinary skill in the art upon reviewing the above description. The scope of the inventive subject matter should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the inventive subject matter and to enable a person of ordinary skill in the art to practice the embodiments of the inventive subject matter, including making and using any devices or systems and performing any incorporated methods. The patentable scope of the inventive subject matter is defined by the numbered claims below, and may include other examples that occur to those of ordinary skill in the art. Such other examples are intended to be within the scope of the claims if they have structural elements that do not differ from the literal language of the claims, or if they include equivalent structural elements with insubstantial differences from the embodiments described by the literal language of the claims.

According to some embodiments, the present disclosure contemplates vehicles with systems and methods for a selective maintenance of way. It may be preferable to selectively eliminate targeted features within an operating vicinity of a vehicle, while sparing non-targeted features within the operating vicinity of the vehicle, adjust a maintenance of way operation, or forgo a maintenance of way operation based on various inputs. For example, although a first vegetation in a region through which a vehicle is traversing may be undesirable and/or may obstruct a route of the vehicle, a second vegetation may not obstruct the route. Accordingly, it may be a waste of resources to eliminate such vegetation.

Alternately or additionally, the second vegetation may be deemed environmentally beneficial and/or may be protected by laws or regulations that vary by region. For example, as the vehicle traverses California, eliminating the environmentally beneficial vegetation may be legally prohibited. However, as the vehicle traverses Nevada, it may not be illegal to eliminate the same vegetation and, therefore it may be desirable to eliminate the vegetation assuming it is obstructing the route and a decision whether or not to perform a maintenance of way operation may be made based on location data associated with a current position of a vehicle. It might be similarly desirable to selectively deposit a fertilizer on beneficial vegetation, assuming the system is capable of accurately distinguish such vegetation, from harmful vegetation.

It may also be inefficient or undesirable to perform maintenance of way operations on certain portions of a route. As previously described, it may be necessary to maintain the way on a first side of a route but unnecessary and, therefore, inefficient to maintain the way on a second side of the route. For example, the second side of the route may not have land—let alone undesirable vegetation. Accordingly, treating both sides of the route would result in a waste of time and/or resources (e.g., chemicals, electrical energy, etc.). Alternately or additionally, a body of water may exist on the second side of the route and thus, depositing chemicals or herbicides on the second side of the route may be undesirable or prohibited by law or regulation. Likewise, as the vehicle traverses a town or city, it might be undesirable to deposit certain chemicals or herbicides in portions of the route that receive large amounts of foot traffic or parked cars to promote safety and the protection of property.

As previously described, the vehicles disclosed herein may utilize sensors (e.g., optical sensors, location sensors, optical sensors, temperature sensors, pressure sensors, range finders, etc.) and/or maps that may indicate certain features and/or portions of the route (e.g., a river on one side of the vehicle at a location on the route and tall weeds in a ditch on the other side, etc.). Sensor data, for example, can be generated by the vehicle and processed via the systems and methods disclosed herein to accurately characterize a condition of a route for the purposes of more specifically tailoring a maintenance of way operation for multiple portions of a route.

Additionally, certain maps may be preferable for a selective maintenance of way. Whereas known systems and methods may be specifically configured for implementation in agriculture and, therefore, may utilize maps that depict a certain area or acreage (e.g., maps of farmland, etc.), it may be preferable to utilize maps specifically tailored to depict a distance between a point of departure and a destination (e.g., maps of routes). Contrary to area-oriented maps, point-to-point maps may enhance the overall knowledge of a route that traverses from point-to-point and, therefore, improve a system's ability to selectively control a maintenance of way system to treat certain portions of the route without treating other portions of the route. In other words, the maps could be more specifically tailored to describe a point-to-point route for a selective maintenance of way instead of relying on area-oriented maps that just so happen to depict a portion of a route. The quality of information provided by point-to-point, route-oriented maps would be better suited for the purposes disclosed herein.

Additionally, according to some embodiments, the vehicles and systems disclosed herein may receive and/or determine parameters based on information provided by external systems. For example, the vehicles and systems disclosed herein may be communicatively coupled to a positive vehicle control (“PVC”) system, or a monitoring system utilized by a vehicle to allow the vehicle system to move outside of a designated restricted manner. A suitable PVC system may be the I-ETMS positive train control system available from Wabtec Corporation. The PVC system may handle vehicle operation, including movement above a designated penalty speed limit, responsiveness to receipt or continued receipt of one or more signals, and the like. The one or more signals may include designated criteria and/or characteristics (e.g., designated waveforms, content, etc.) and/or may be received at designated times or in accordance with other designated time criteria. The signals may be received under other designated conditions. The remote node may include a “negative” vehicle monitoring system that does not allow vehicles to move unless a determined signal or set of information is received.

Furthermore, the vehicles and systems disclosed herein may include different types of maintenance of way subsystems (e.g., spray systems, lasers, etc.) configured to eliminate different types of targeted objects (e.g., obstructing vegetation, beneficial vegetation or crops, debris, leaves, branches, rocks, soil, mud, fire, ice, water, etc.) in different ways, depending on the specific type of object being targeted. For example, as previously described, different spray systems may utilize emitters (e.g., dispensers) configured for use with different functional fluids, including one or more of a metal corrosion inhibitor, a friction modifier or lubricant, a dust reducer, a fire retardant or suppressant, and the like to achieve a desired affect on the route, the ballast, the ties, the rail, the wayside, and structures and items found adjacent to routes over which the vehicle may travel. Emissions can further include liquids (e.g., magnesium chloride, calcium chloride, alcohol, etc.), solids (e.g., sodium chloride), or gasses (e.g., compressed air, gaseous chemicals, etc.) configured for specific maintenance of way operations. It shall therefore be appreciated that, according to some embodiments, the vehicles and systems disclosed herein may include spray systems with numerous dispensers configured to dispense numerous functional fluids. According to such embodiments, the emitters may be specifically configured to generate emissions that include a particular stream of a chemical composition (e.g., herbicide, fertilizer, fire suppressant, etc.) specifically configured to eliminate the targeted feature (e.g., weed, crop, fire, etc.), wherein the targeted feature is determined based on parameters associated with the operating vicinity of the vehicle. According to some embodiments, the maintenance of way systems may include temperature sensors and/or heaters to control a temperature of a fluid or emission.

According to still other embodiments, the vehicles and systems disclosed herein can include different types of maintenance of way systems. For example, according to some embodiments, the vehicles and systems disclosed herein can include emitters configured to emit an electromagnetic radiation specifically configured to eliminate a targeted feature. Such emitters can include lasers or other emitters configured to emit thermal energy. However, according to other embodiments non-emission based maintenance of way systems can be implemented to effectively maintain a route, including grinders and/or excavators. In other words, the maintenance of way systems disclosed herein can include systems for the mechanical removal of obstructions. As will be described in further detail, the maintenance of way systems described herein can include combinations of the aforementioned emitters and techniques to ensure the systems are capable of flexible and diverse means of maintenance of way that can be customized based on a variety of inputs used to determine parameters associated with the operating vicinity of a vehicle. The vehicles, systems, and methods disclosed herein may intelligently customize such operations in real-time for different portions of a route for optimal efficiency and efficacy.

In summary, the selective maintenance of way systems and methods disclosed herein can be based on certain parameters associated with the operating vicinity of the vehicle. Such parameters can include or be determined based on information obtained by the control system or other sensors associated with the vehicle and/or route (e.g., optical sensors, location sensors, optical sensors, temperature sensors, pressure sensors, range finders, etc.), as previously described herein. According to some embodiments, the parameters can include or be determined based on information provided via a source external to the vehicle, such as a PVC system. According to still other embodiments, the parameters can include or be determined based on maps associated with a route. The systems and methods disclosed herein may also include different types of maintenance of way systems, including multiple emitters (e.g., emitters configured to emit different chemical sprays, emitters configured to emit electromagnetic radiation, etc.), which may be selectively activated based on the determined parameters.

As will be described in further detail herein, parameters associated with the operating vicinity of the vehicle can be determined and/or otherwise processed by an artificial intelligence model and/or a machine vision model (e.g., a machine vision model that utilizes artificial intelligence) to autonomously determine features of a route, what portions of route should be maintained, what portions of a route should not be maintained, as well as a specific means of maintenance that should be employed. For example, based on the determined parameters associated with the operating vicinity of the vehicle, an artificial intelligence model and/or machine vision model may autonomously determine that a targeted weed exists along a first portion of a route, a non-targeted beneficial plant exists along a second portion or direction of the route, corrosion exists along a third portion of the route, and that a fourth portion of the route traverses a heavily populated city. Accordingly, the artificial intelligence model and/or machine vision model may autonomously cause the emission of an herbicide on the first portion of the route, a fertilizer on the second portion of the route, and an electromagnetic radiation configured to eliminate rust on the third portion of the route, while preventing maintenance of way operations from occurring along the fourth portion of the route. Accordingly, the vehicles, systems, and methods disclosed herein can be specifically configured to selectively maintain a route based on parameters associated with a vehicle and/or route, which improves quality, safety, and efficiency of operation.

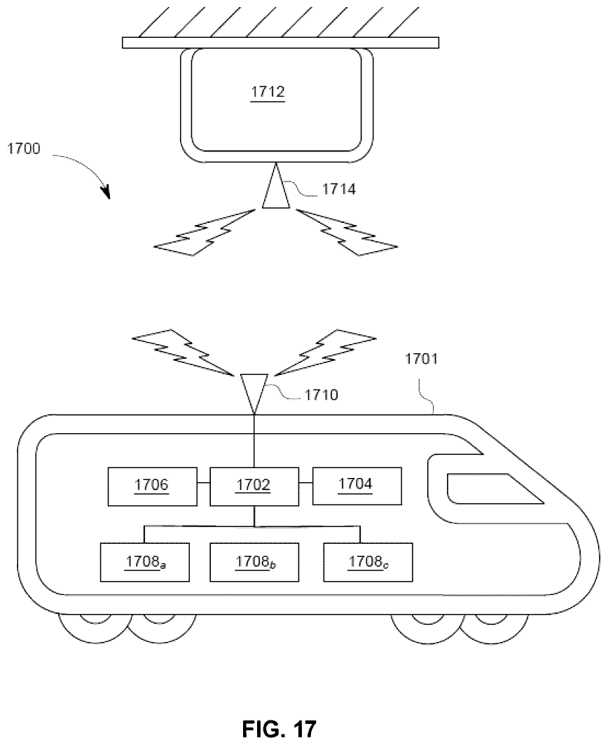

Referring to FIG. 17, a diagram of a system 1700 configured for selective and intelligent maintenance of way is depicted in accordance with one embodiment of the present disclosure. The system may include at least one vehicle 101. For example, the vehicle may be a first vehicle of a plurality of coupled vehicles. It shall be appreciated that the vehicles may be mechanically coupled with each other (e.g., by couplers) or communicatively coupled but not mechanically coupled. For example, vehicles may be communicatively but not mechanically coupled when the separate vehicles communicate with each other to coordinate actions and/or movements of the vehicles with each other so that the vehicles travel together (e.g., as a convoy). Accordingly, it shall be appreciated that, according to other embodiments, the components of the system of FIG. 17 can be distributed across one or more vehicles of a plurality of coupled vehicles. According to the example of FIG. 17, the vehicle is a head-of-train (HOT) rail vehicle. Although rail vehicles are used by the present disclosure to illustrate the various examples described herein, other suitable vehicles may include automobiles, aircraft, marine vessels, agricultural and construction equipment, mining vehicles, and the like. For example, in other embodiments, the vehicle is an automobile, a boat, a submarine, a plane, a hovercraft, a drone, and a spacecraft. As such, it shall be appreciated that the concepts disclosed herein may be implemented via any suitable vehicle.

In further reference to FIG. 17, the vehicle may include system components, such as a control circuit 1702, a memory 1704, one or more sensors 1706, one or more maintenance of way subsystems 1708_{a-c}, and/or a first communication circuit 1710. The communication circuit, for example, may include a transceiver (or separate transmitter and/or receiver, as desired) configured to be communicatively coupled to other vehicles of a plurality of coupled vehicles or an external source. The vehicle may be communicatively coupled to a separate transmitter and/or receiver in lieu of a transceiver, as desired. According to some embodiments, the communication circuit is configured to establish a radio communication link.

The external source may include a remote node 1712 that may include a second communication circuit 1714, which may include either a transceiver or or a separate transmitter and receiver, as desired. The remote node may include a wayside station, a back office, and/or any other remote node capable of communicating with the vehicle. The remote node may remain stationary relative to the vehicle. As the vehicle varies in distance relative to the remote node, it may be desirable to establish a longer-range communication link between the first and second communication devices or handoff to successive devices. Suitable links may include Wi-Fi, cellular, or satellite link, rather than a more geographically oriented communication link. Using a remote node, the system may benefit from enhanced processing capabilities. Systems with more processing capabilities may be desirable for enhanced train operations, including advanced collision controls, overspeed checks, and/or unauthorized movement preventions, all of which may benefit from the enhanced processing provided by remote node.

According to some embodiments, the remote node may include a PVC system, or a monitoring system utilized by a vehicle to allow the vehicle system to move outside of a designated restricted manner. The remote node, therefore, may be configured to transmit signals to and from the vehicle. Such signals may include designated criteria and/or characteristics (e.g., designated waveforms, content, etc.) and/or may be received at designated times or in accordance with other designated time criteria. The signals may be received under other designated conditions and may include certain information associated with the vehicle, a route on which the vehicle is traversing, and/or the operating vicinity of the vehicle. It shall be further appreciated that, according to other embodiments, the remote node may include a “negative” vehicle monitoring system that does not allow vehicles to move unless a determined signal or set of information is received.

Still referring to FIG. 17, the one or more sensors may include any of the aforementioned sensors, including optical sensors, location sensors, optical sensors, temperature sensors, pressure sensors, and/or range finders, amongst others. According to some embodiments, the one or more sensors may include the sensors of the control system and/or portable system previously described in reference to FIG. 1, or components thereof. The one or more sensors may also include the sensors described in reference to FIG. 4. It shall be appreciated that such sensors can generate sensor data that may include information associated with the vehicle, a route on which the vehicle is traversing, and/or the operating vicinity of the vehicle. According to some embodiments, the one or more sensors may be positioned on different vehicles of a plurality of coupled vehicles and thus, may be configured to generate sensor data that may include information associated with different parts of the plurality of coupled vehicles, different portions of a route, and/or different portions of the operating vicinity.

According to the embodiment shown in FIG. 17, the one or more maintenance of way subsystems may include any of the aforementioned systems. For example, the maintenance of way subsystems may include at least one spray system, as described in references to FIG. 10. As such, it shall be appreciated that the one or more maintenance of way subsystems may include one or more emitters (e.g., dispensers, nozzles, lasers, etc.) and, according to some embodiments, mechanisms (e.g., controllable/retractable masts) by which the emitters can be moved relative to the vehicle in response to controls received from the control circuit and/or portable unit, as described in reference to FIG. 1. In other words, the one or more maintenance of way subsystems may allow for controlled movement and deployment of the maintenance equipment and/or the emitters. The one or more maintenance of way subsystems and emitters may be communicatively coupled to the control circuit.

As previously described, one or more of the maintenance of way subsystems may utilize different emitters configured for use with different functional fluids, including one or more of a metal corrosion inhibitor, a friction modifier or lubricant, a dust reducer, a fire retardant or suppressant, and the like to achieve a desired affect on the route, the ballast, the ties, the rail, the wayside, and structures and items found adjacent to routes over which the vehicle may travel. According to other embodiments, one or more of the maintenance of way subsystems can include emitters configured to emit an electromagnetic radiation specifically configured to eliminate a targeted feature. Such emitters can include lasers or other emitters configured to emit thermal energy. The lasers, for example, may be powered by an existing power source and/or propulsion system of the vehicle. According to still other embodiments, one or more of the maintenance of way subsystems may be configured for non-emission based maintenance, including either a grinder or an excavator.

It shall be appreciated that, according to embodiments wherein the emitter is configured to emit electromagnetic radiation, fewer tanks or chemicals may be necessary and environmental benefits may be achieved (e.g., no herbicides). This may be beneficial for compliance with certain laws or regulations. Additionally, the same emitters may be used for the removal of harmful or obstructing plants as are used for the removal of corrosion or other debris that may respond in a beneficial way to electromagnetic radiation. Such emissions may be less susceptible to environmental conditions such as rain or wind (e.g., will not wash off, may be more accurate on a windy day, etc.). Furthermore, depending on the targeted object, use of such emitters can be adjusted and/or oriented. For example, if a targeted object includes a tree, an emitter of electromagnetic radiation can be configured for a girdling process, or the circumferential removal and/or injury of the bark of a branch or trunk. However, if the targeted object includes a smaller plant or weed, the emitter can be configured to focus on a meristem of the plant. The maintenance of way models disclosed herein may be configured to target certain features (e.g., obstructing plants, leaves, corrosion, ice, etc.) without effecting non-targeted objects (e.g., beneficial plants, people, equipment, property, etc.).

Accordingly, the one or more maintenance of way subsystems may be configured for different applications. For example, a first maintenance of way subsystem 1708a may be configured for a first emission (e.g., an herbicide), a second maintenance of way subsystem 1708b may be configured for a second emission (e.g., a fertilizer), and a third maintenance of way subsystem 1708c may be configured for a third emission (e.g., electromagnetic energy). Of course, according to some embodiments, a single maintenance of way subsystem may be configured for different types of emissions via a single emitter. For example, a single maintenance of way subsystem may be configured to access two or more reservoirs containing different fluids and, therefore, may be capable of emitting a first emission (e.g., an herbicide) and a second emission (e.g., a fertilizer). Additionally, as previously discussed, the one or more maintenance of way subsystems may include a plurality of emitters (e.g., nozzles) configured to focus emissions in different directions, at different heights, and at different angles. Accordingly, the one or more maintenance of way subsystems can be selectively activated for different emissions in different directions based on signals received from the control circuit. According to some embodiments, the maintenance of way systems may be air or liquid configured to remove debris such as leaves from the route. According to other embodiments, the fluids may be heated to a certain temperature to assist with the removal of ice, corrosion, or other obstructions from the route.

According to the embodiment shown in FIG. 17, the control circuit may include a portable unit, as described in reference to FIG. 1, or components thereof. The memory, for example, may be configured to store a maintenance of way model and/or predetermined information associated with the vehicle and/or route. The maintenance of way model, when executed by the control circuit, may cause the control circuit to perform the functionality and methods disclosed herein based on certain inputs received from the one or more sensors, remote node, or stored in the memory. The control circuit can include one or more central processing unit (CPU) cores, graphics processing unit (GPU) cores, and/or artificial intelligence accelerator cores specifically configured to execute the maintenance of way model either alone or in parallel to perform the artificial intelligence/machine vision functionality described herein. The control circuit may be communicably coupled to one or more operational systems of the vehicle. For example, as previously described, the control circuit can be configured to control operations of the vehicle, such as by communicating command signals to a propulsion system of the vehicle (e.g., motors, engines, brakes, or the like) for controlling output of the propulsion system. That is, the control system can control the movement of the vehicle, as well as its speed and/or direction.

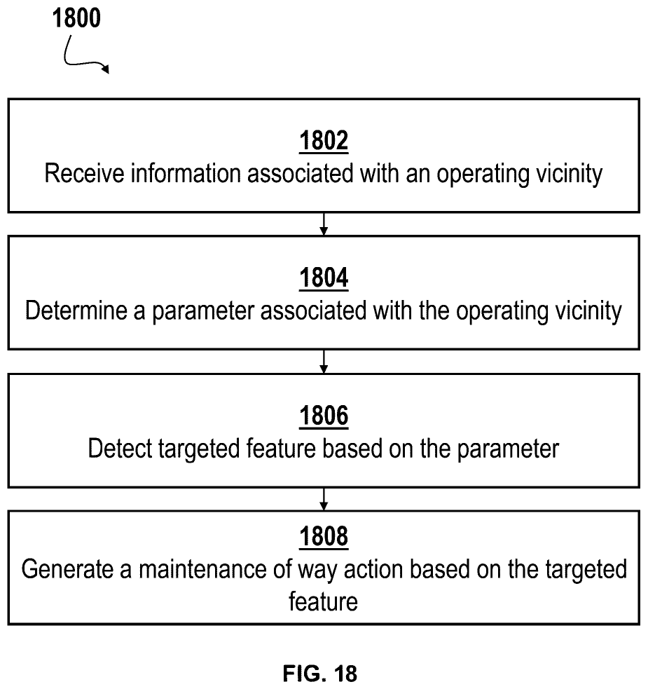

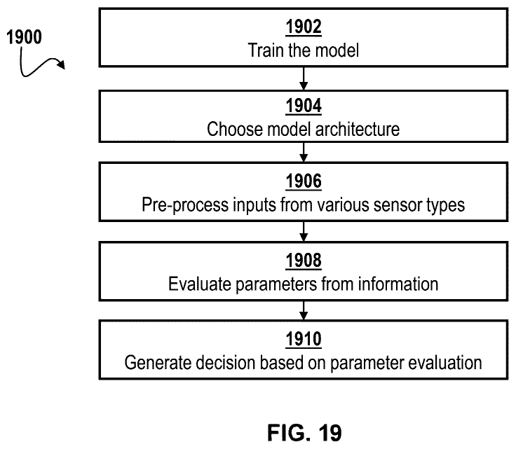

As will be discussed in further detail with reference to FIGS. 18 and 19, the maintenance of way model may include a machine vision model—or any other artificial intelligence model—configured to cause the control circuit to receive information from the one or more sensors, memory, or remote node, determine a parameter associated with an operating vicinity of the vehicle, detect the targeted feature based, at least in part, on the parameter, and selectively control one or more maintenance of way subsystems. For example, the control circuit can receive information, for example, can include information (e.g., image data, audio data, vibration data, location information, humidity data, pressure data, moisture data, etc.) from the one or more sensors, meteorologic information from the remote node, a map of the route (e.g., including the location of bridges, properties, bodies of water, cities, farms, etc.) from the remote node or the memory, demographic information (e.g., populations, etc.), regulatory information (e.g., lists of prohibited objects associated with a portion of the route), wayside information, traffic information, and/or historic information (e.g., vehicle speed of past maintenance of way operations, use of certain emitters of certain maintenance of way subsystems, efficacy of past maintenance of way operations).

Such information may be provided to the maintenance of way model as an input and, based on the input, the maintenance of way model may cause the control circuit to determine a parameter (e.g., presence of route obstructing vegetation on a portion of the route, presence of beneficial vegetation on a portion of the route, presence of corrosion on the route, a current weather condition of the route, etc.) associated with the operating vicinity of the vehicle. For example, based on image data generated by the one or more sensors, the control circuit may be able to distinguish harmful, route obstructing vegetation from beneficial or legally protected vegetation. Based on the determined parameter, the maintenance of way model may cause the control circuit to selectively control the one or more maintenance of way subsystems.

For example, according to some embodiments, the maintenance of way model may cause the control circuit to generate and/or transmit a signal that causes an adjustment to an operational parameter associated with an emitter of the one or more maintenance of way subsystems. The altered operational parameter may cause the emitter to selectively focus on a targeted feature (e.g., route obstructing vegetation). The maintenance of way model may further cause the control circuit to generate and/or transmit a signal that causes the emitter to direct an emission toward the targeted feature while sparing non-targeted features (e.g., beneficial vegetation, vegetation that is not obstructing the route, vegetation that is illegal to eliminate, etc.) within the operating vicinity. The adjustment may be implemented via one or more masts and/or couplers of the maintenance of way subsystem. Depending on the targeted object, the emission may include a chemical (e.g., herbicide, fertilizer, fire retardant or suppressant, etc.) or an electromagnetic radiation. Additionally, emissions may be timed or pulsed based on determined parameters and detected features within the operating vicinity. For example, a certain number of pulses of an emission at a certain frequency may be determined to be preferable based on determined parameters (e.g., type of targeted object, vehicle speed, wind, rain, snow, sun, temperature, etc.).

According to some embodiments, the maintenance of way model may cause the control circuit to selectively initiate an emission from a first maintenance of way subsystem without initiating an emission from a second maintenance of way subsystem. For example, the maintenance of way model may cause the control circuit to determine that an emitter of the first maintenance of way subsystem is properly oriented at the target object (e.g., positioned on a first side of the vehicle) and an emitter of the second maintenance of way subsystem is not properly oriented at the target object (e.g, positioned on a second side of the vehicle). Alternately, the maintenance of way model may cause the control circuit to determine that a first emitter of the first maintenance of way subsystem is properly configured for a first emission (e.g., the emitter is fluidically coupled to a reservoir containing an herbicide) and that a second emitter of the second maintenance of way subsystem is not properly configured for the first emission (e.g., the emitter is is fluidically coupled to a reservoir containing a fertilizer).

According to other embodiments, the maintenance of way model may cause the control circuit to determine that a first parameter (e.g., presence of route obstructing vegetation) exists in a first portion of the route and a second parameter (e.g., presence of beneficial vegetation) exists in a second portion of the route. As such, the maintenance of way model may cause the control circuit to selectively orient a first emitter of the first maintenance of way subsystem to focus on the route obstructing vegetation based on the first parameter and initiate a first emission (e.g., an herbicide, electromagnetic radiation configured to eliminate the route obstructing vegetation). Likewise, the maintenance of way model may cause the control circuit to selectively orient a second emitter of the second maintenance of way subsystem to focus on the beneficial vegetation based on the second parameter and initiate a second emission (e.g., a fertilizer).

According to some embodiments, the maintenance of way model may be configured to cause the control circuit to alter an operational parameter such that the emission itself is altered based on a determined parameter. For example, the control circuit may receive historic information and determine that past maintenance of way operations were not effective during based on certain parameters, such as weather conditions and/or under vehicle operational parameters (e.g., speed of vehicle, direction of vehicle, location of vehicle, vehicle configuration, etc.). Accordingly, the maintenance of way model may be configured to cause the control circuit to alter an emission of an emitter of a maintenance of way subsystem. For example, the maintenance of way model may be configured to cause the control circuit to alter a chemical composition of the emission by using a different herbicide or fertilizer tailored for the targeted object, or alter an electromagnetic frequency and/or wavelength of electromagnetic radiation. According to some embodiments, the quantity and/or nature of the emission (e.g., a mist, a spritz, a spray, a stream) may be altered. For example, under certain weather conditions or vehicle operational parameters, the maintenance of way model may cause the control circuit to determine that a mist may be appropriate, whereas others may benefit from a stream. The altered emission may be configured to achieve a different result or efficacy relative to the historical information.

Alternately, an “adder” or thickener may be included in the emission, such that the emission sticks during certain weather conditions, such as rain, wind, or snow or based on particular vehicle operational parameters. For example, the historical information my indicate that, at a particular vehicle speed, an “adder” or thickener may be included in the emission, so the emission drops on the targeted object and sticks. Alternately, an emitter on a particular vehicle (e.g., a HOT vehicle) may benefit from an adder such that subsequent vehicles do not disturb or displace the chemical composition as the vehicle traverses the route. The same may be applicable to traffic information received from the remote node, as heavily trafficked routes may also disturb or displace chemical compositions if the emissions are not altered. According to some embodiments, the maintenance of way model may cause the control circuit to alter operational parameters of the vehicle to increase the efficacy of the maintenance of way operation. For example, the maintenance of way model may cause the control circuit to reduce a vehicle speed if the historical information indicates that maintenance of way operations performed above a certain speed decreases efficacy.

According to some embodiments, combinations of emitter and/or vehicle operating parameters may be adjusted for different portions of a route. For example, parameters such as vehicle speed, emitter orientation, emission quantity, pulse of emission, frequency of emission, frequency composition, use of adders, and/or types emissions may be adjusted together to more specifically address a targeted object, avoid non-targeted objects, and more effectively maintain the condition of the route. It shall be appreciated that the vehicles, systems, and methods disclosed herein may customize operations by adjusting such parameters in real-time for different portions of a route, resulting in dynamic maintenance of way operations that are more efficient and more effective.

Referring to FIG. 18, an algorithmic flow diagram of a method 1800 for selective maintenance of way is depicted according to an embodiment of the invention. It shall be appreciated that, according to the embodiment, the method can be implemented by the control circuit of the system of FIG. 17 in response to the maintenance of way model stored in the memory of the system of FIG. 17. As previously explained, the maintenance of way model may include a machine vision model—or any other artificial intelligence model—configured to cause the control circuit to perform the method of FIG. 18 and any additional functionality described herein. It shall be appreciated that, although the non-limiting aspect of FIG. 18 illustrates the use of a transformer-based model that may use language modeling and/or task-generation to generate outputs to be implemented by the control circuit for the selective maintenance of way, the present disclosure contemplates other embodiments that use other models. For example, according to some embodiments, sequence-to-sequence models (e.g., for machine translation), attention mechanisms (e.g., to understand context), recurrent neural networks (e.g., to generate code and create code structure), long short-term memory networks, reinforcement learning models (e.g., to fine-tune and optimize code), generational adversarial networks (e.g., to generate and discriminate code to promote accuracy), and/or variational autoencoders (e.g., to compress data into a latent space) may be implemented for the selective maintenance of way, amongst others. According to some embodiments, a convolutional neural network (CNN) may be used. According to other non-limiting embodiments, a hybrid model may be used, combining aspects of other models to achieve the same effect.

According to the non-limiting embodiment of FIG. 18, the method can include receiving 1802 information associated with an operating vicinity of a vehicle. As previously discussed, the information can be received from one or more sensors, a memory, or a remote node The received information, for example, can include image data, audio data, vibration data, location information, humidity data, pressure data, moisture data, meteorologic information, a map of a route (e.g., including the location of bridges, properties, bodies of water, cities, farms, etc.), demographic information (e.g., populations, etc.), regulatory information (e.g., lists of prohibited objects associated with a portion of the route), wayside information, traffic information, and/or historic information (e.g., vehicle speed of past maintenance of way operations, use of certain emitters of certain maintenance of way subsystems, efficacy of past maintenance of way operations), amongst other types of information. Such information may be provided to the maintenance of way model as an input.

Still referring to FIG. 18, the method can further include determining 1804 a parameter associated with the operating vicinity of the vehicle based on the received information. For example, wherein the method aspires to detect features of the operating vicinity of the vehicle, parameters can include any characteristics of features within the operating vicinity. According to some embodiments, parameters may be indicative of a position of a targeted feature, a characteristic of the targeted feature, a route of the vehicle, a speed or orientation of the vehicle, or an ambient condition of the operating vicinity. Specifically, parameters May include a type of targeted feature (e.g., a type of vegetation, a weather condition, a hazard, etc.), a distance of the targeted object from the vehicle, a color of the targeted object, a temperature of the targeted object (e.g., useful for detecting ice, fire, living creatures, etc.), positional coordinates, a humidity level, a pressure level, or a wind speed, or combinations thereof. A specific means of algorithmic parameter determination and feature detection will be described in further detail with reference to FIG. 19. Based on determined parameters, certain features can be detected, including targeted objects (e.g., obstructing vegetation, corrosion, leaves, hazards such as ice, mud, fire, etc.), specific portions of route, weather conditions, regulations associated with the route, and/or hazards associated with the route can be determined based on other information provided by the sensors and/or the remote node, or stored in the memory.

In further reference to FIG. 18, the method can further include detecting 1806 a targeted feature based, at least in part, on the determined parameter. The detection can include distinguishing the targeted object form a non-targeted object. Such distinctions may be based on feature extraction of recognized characteristics or patterns, other sensor data, or information stored by the memory or provided by the remote node, or combinations thereof. For example, the remote node may transmit information that a targeted object (e.g., obstructing vegetation, corrosion, hazards, such as ice, fires, etc.) may be present at a particular portion of the route, and based on a map, location data and/or other sensor data, the maintenance of way model may cause the control circuit to detect or confirm the presence of the targeted object at the particular portion of the route.

The method can further include generating 1808 a maintenance of way action based on the targeted feature. For example, according to some embodiments, the maintenance of way action may include an adjustment of an emitter of a maintenance of way subsystem to selectively focus on the targeted feature and direct an emission toward the targeted feature while sparing non-targeted features within the operating vicinity. The adjustment may be implemented via one or more masts and/or couplers of the maintenance of way subsystem. Depending on the targeted object, the emission may include a chemical (e.g., herbicide, fertilizer, fire retardant or suppressant, etc.) or an electromagnetic radiation. According to some embodiments, the maintenance of way action may include selectively initiating an emission from a first maintenance of way subsystem without initiating an emission from a second maintenance of way subsystem. According to other embodiments, the maintenance of way action may include orienting a first emitter of the first maintenance of way subsystem to focus on the targeted object (e.g., route obstructing vegetation, corrosion, fire, ice, etc.) and initiating a first emission (e.g., an herbicide, electromagnetic radiation configured to eliminate the route obstructing vegetation, a fire suppressant, etc.). The maintenance of way action may further include orienting a second emitter of the second maintenance of way subsystem to focus on a second targeted object (e.g., beneficial vegetation) and initiating a second emission (e.g., a fertilizer). According to some embodiments, the adjustment can include an adjustment to a temperature of a fluid emitted by the maintenance of way subsystem.

According to some embodiments, the control circuit may receive historic information and determine that past maintenance of way operations were not effective during based on certain parameters, such as weather conditions and/or under vehicle operational parameters (e.g., speed of vehicle, direction of vehicle, location of vehicle, vehicle configuration, etc.). Accordingly, the maintenance of way action may include altering an emission of an emitter of a maintenance of way subsystem. For example, the maintenance of way model may be configured to cause the control circuit to alter a chemical composition of the emission by using a different herbicide or fertilizer tailored for the targeted object, or alter an electromagnetic frequency and/or wavelength of electromagnetic radiation. According to some embodiments, the quantity and/or nature of the emission (e.g., a mist, a spritz, a spray, a stream) may be altered. For example, under certain weather conditions or vehicle operational parameters, the maintenance of way model may cause the control circuit to determine that a mist may be appropriate, whereas others may benefit from a stream. The altered emission may be configured to achieve a different result or efficacy relative to the historical information.

Alternately, an “adder” or thickener may be included in the emission, such that the emission sticks during certain weather conditions, such as rain, wind, or snow or based on particular vehicle operational parameters. For example, the historical information my indicate that, at a particular vehicle speed, an “adder” or thickener may be included in the emission, so the emission drops on the targeted object and sticks. Alternately, an emitter on a particular vehicle (e.g., a HOT vehicle) may benefit from an adder such that subsequent vehicles do not disturb or displace the chemical composition as the vehicle traverses the route. The same may be applicable to traffic information received from the remote node, as heavily trafficked routes may also disturb or displace chemical compositions if the emissions are not altered. According to some embodiments, the maintenance of way model may cause the control circuit to alter operational parameters of the vehicle to increase the efficacy of the maintenance of way operation. For example, the maintenance of way model may cause the control circuit to reduce a vehicle speed if the historical information indicates that maintenance of way operations performed above a certain speed decreases efficacy.

According to some embodiments, the maintenance of way action may include an omission or a determination to forgo an emission based on the determined parameter. For example, such determinations may be based on a determination that the determined parameter is outside of a determined range. For example, the maintenance of way model may be trained to detect features (e.g., a plant type) based on a certain leaf or stem size, as defined by a predetermined range. If the maintenance of way model determines that the leaf or stem size is outside of the predetermined range, it may not be able to conclusively detect a feature and thus, will omit the emission based on an abundance of caution. Alternately, the determination to forgo an emission may be based on a determination that the targeted object is within a determined distance of the non-targeted feature or a determination that the targeted object is unknown to the maintenance of way model. As such, the maintenance of way action may further include an instruction to obtain more information associated with the parameter and/or object, or to assigning the omitted emission to another vehicle that may include additional sensors or information associated with the parameter or feature.

Referring to FIG. 19, an algorithmic flow diagram of a method 1900 of determining a parameter and detecting a feature associated with an operating vicinity of a vehicle is depicted according to an embodiment of the invention. According to the non-limiting embodiment of FIG. 19, the method can include training 1902 the maintenance of way model using a data set relevant to the intended application. For example, if the features to be detected include plants, hazards, rail conditions, locations, and weather conditions, then information, including sensor data, associated with parameters of the features should be included in the training data. The training date may include a diverse set of labeled data from various sources including captured images or video of route conditions, traffic signs, and obstacles, three-dimensional point clouds or distance measurements for object detection and mapping, location and/or inertial measurement data associated with various vehicle positions, velocities, and orientations, weather sensor data, including temperatures, humidities, and precipitation levels (e.g., rain, fog, snow), and/or traffic data such as vehicle flow, route congestion, traffic light states, wayside information, amongst others. The data should be labeled, tagging parameters (e.g., characteristics) of features (e.g., plants, other vehicles, cars, pedestrians, traffic signs) and conditions (e.g., wet rails, snow, fog, etc.) that could effect vehicle operation. For example, images of may be labeled with bounding boxes identifying vehicles, rails, lanes, pedestrians, while other sensor data might be annotated with object distance.

The method can further include choosing 1904 a model architecture to identify and classify parameters and ultimately features. For example, object detection models, segmentation models, and/or RNNs, or Long Short-Term Memory networks (LSTMs) may be used for identification and classification of parameters and features, as well as predictions, wherein parameters may be determined to be outside of a predetermined range or otherwise uncertain. The method can further include pre-processing 1906 inputs from various sensor types. For example, sensor fusion may be preferable to more accurately determine parameters within the operating vicinity of the vehicle and detect features based on the parameters. Pre-processing can include filtering or smoothing applied to clean the data and, according to some embodiments, use of sensor fusion to combine data from multiple sensors for a more accurate perception of the environment.

In further reference to FIG. 19, the method can further include evaluating 1908 parameters from the information associated with the operating vicinity of the vehicle. For example, based on the training data, the maintenance of way model may determine certain predetermined ranges for each parameter, which may inform the evaluation of such parameters in sensor data and other information associated with the operating vicinity of the vehicle. According to embodiments where the maintenance of way model includes machine-vision techniques, the evaluation may further include use of filters (e.g., Gaussian blur) to normalize image data, detect edges based on changes in intensity to assist in object detection, segmentation of image data based on regions of contrast (e.g., via thresholding, clustering by K-means clustering, pixel grouping, and division of objects that are touching), parameter extraction based on recognized characteristics or patterns (e.g., as learned via model training), and feature subsequent detection based on the parameter extraction. Finally, the method can include generating 1910 a decision based on the parameter evaluation. For example, if the parameters are determined to be within the predetermined range, the maintenance of way model may decide that a specific feature or object has been detected.

Examples of the methods and systems disclosed herein, according to various aspects of the present disclosure, are provided below in the following embodiments. An aspect of the methods may include any one or more than one of, and any combination of, the embodiments described below.

In a first embodiment, the present disclosure provides a vehicle, including an emitter adjustable to selectively focus on a targeted feature within an operating vicinity of the vehicle, and a control circuit communicatively coupled to the emitter, wherein the control circuit is to determine a parameter associated with the operating vicinity of the vehicle, detect the targeted feature based, at least in part, on the parameter, adjust the emitter to selectively focus the emitter with respect to the targeted feature, and cause the emitter to direct an emission toward the targeted feature while sparing non-targeted features within the operating vicinity.

Additionally, in the first embodiment, the control circuit can be configured to detect, adjust, or both detect and adjust based on an artificial intelligence model using values of the parameter to control the emitter. The control circuit can be configured to alter an operational parameter of the emitter responsive at least in part to the artificial intelligence model. The parameter can further include at least one of a type of targeted object, a distance of the targeted object from the vehicle, a color of the targeted object, a temperature of the targeted object, a humidity level, a pressure level, or a wind speed, or combinations of two or more thereof. The control circuit can be further configured to forgo or omit the emission toward the targeted feature based at least in part on the parameter being outside a determined range, the targeted feature being within a determined distance of a determined non-targeted feature, or the targeted feature being unknown to an artificial intelligence model associated with the control circuit. The control circuit can be further configured to assign a task to perform the forgone or omitted emission by another vehicle. The parameter can be indicative of one or more of a position of the targeted feature, a characteristic of the targeted feature, a route of the vehicle, a speed or orientation of the vehicle, and an ambient condition of the operating vicinity. The vehicle can further include a sensor to monitor the parameter, wherein the sensor comprises at least one of an optical sensor, a location sensor, a temperature sensor, a pressure sensor, or a range finder, or combinations thereof. The control circuit can be further configured to adjust an operational parameter of the vehicle to increase an accuracy of the emission in reaching the targeted feature. The operational parameter can include at least one of a speed of the vehicle or a direction of the vehicle, or combinations thereof. The emission can include an electromagnetic radiation to eliminate the targeted feature. The emission can include a stream of a chemical composition to eliminate the targeted feature. The vehicle can further include a mast supporting the emitter, and a coupler communicatively coupled to the control circuit and configured to move the mast, and thereby to adjust the emitter.

In a second embodiment, the present disclosure provides a method including the steps of determining a parameter associated with an operating vicinity of a vehicle, distinguishing a targeted feature from a non-targeted feature based, at least in part, on the parameter, adjusting an emitter to selectively focus the emitter with respect to the targeted feature, and activating the emitter to direct an emission exclusively and only toward the targeted feature and not toward a non-targeted feature within the operating vicinity.

Additionally, in the second embodiment, the method can further include training an artificial intelligence model based at least in part on values of the parameter, and thereby to improve a future distinction of the targeted feature from the non-targeted feature. Activating the emitter can include directing electromagnetic radiation and/or streaming a chemical composition.

In a third embodiment, the present disclosure provides a system including a control circuit configured to determine a parameter associated with an operating vicinity of the system, use machine vision to detect a targeted feature based, at least in part, on the parameter, activate a coupler to selectively aim an emitter at the targeted feature; and, activate the emitter to emit an emission toward the targeted feature while sparing non-targeted features within the operating vicinity.

Additionally, in the second embodiment, the control circuit can be disposed on a first vehicle of a plurality of coupled vehicles, and the emitter can be disposed on a second vehicle of the plurality of coupled vehicles. The system can further include a sensor to monitor the parameter. The sensor can include at least one of an optical sensor, a location sensor, an optical sensor, a temperature sensor, a pressure sensor, or a range finder, or combinations of two or more thereof.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Movement of a vehicle system may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, and matching speeds and directions between vehicles in a vehicle group. Indirectly, movement of the vehicle may include ramping up (or down) power sources; and this may include energizing electrical circuits or buses, setting fuel flow rates, setting engine RPM rates, and the like.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term “non-transitory computer-readable medium” refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. raw data gathered by these sensors may feed into the control circuit, which in turn can respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A vehicle, comprising:
an emitter adjustable to selectively focus on a targeted feature within an operating vicinity of the vehicle; and
a control circuit communicatively coupled to the emitter, wherein the control circuit is to:
determine a parameter associated with the operating vicinity of the vehicle;
detect the targeted feature based, at least in part, on the parameter;
adjust the emitter to selectively focus the emitter with respect to the targeted feature; and
cause the emitter to direct an emission toward the targeted feature while sparing non-targeted features within the operating vicinity.

2. The vehicle of claim 1, wherein the control circuit is configured to detect, adjust, or both detect and adjust based on an artificial intelligence model using values of the parameter to control the emitter.

3. The vehicle of claim 2, wherein the control circuit is configured to alter an operational parameter of the emitter responsive at least in part to the artificial intelligence model.

4. The vehicle of claim 3, wherein the parameter comprises at least one of a type of targeted object, a distance of the targeted object from the vehicle, a color of the targeted object, a temperature of the targeted object, a humidity level, a pressure level, or a wind speed, or combinations of two or more thereof.

5. The vehicle of claim 1, wherein the control circuit is configured to forgo or omit the emission toward the targeted feature based at least in part on:
the parameter being outside a determined range;
the targeted feature being within a determined distance of a determined non-targeted feature; or
the targeted feature being unknown to an artificial intelligence model associated with the control circuit.

6. The vehicle of claim 5, wherein the control circuit is configured to assign a task to perform the forgone or omitted emission by another vehicle.

7. The vehicle of claim 1, wherein the parameter is indicative of one or more of:
a position of the targeted feature;
a characteristic of the targeted feature;
a route of the vehicle;
a speed or orientation of the vehicle; and
an ambient condition of the operating vicinity.

8. The vehicle of claim 1, further comprising a sensor to monitor the parameter, wherein the sensor comprises at least one of an optical sensor, a location sensor, a temperature sensor, a pressure sensor, or a range finder, or combinations thereof.

9. The vehicle of claim 1, wherein the control circuit is further configured to adjust an operational parameter of the vehicle to increase an accuracy of the emission in reaching the targeted feature.

10. The vehicle of claim 9, wherein the operational parameter comprises at least one of a speed of the vehicle or a direction of the vehicle, or combinations thereof.

11. The vehicle of claim 1, wherein the emission comprises an electromagnetic radiation to eliminate the targeted feature.

12. The vehicle of claim 1, wherein the emission comprises a stream of a chemical composition to eliminate the targeted feature.

13. The vehicle of claim 1, further comprising a mast supporting the emitter, and a coupler communicatively coupled to the control circuit and configured to move the mast, and thereby to adjust the emitter.

14. A method, comprising:
determining a parameter associated with an operating vicinity of a vehicle;
distinguishing a targeted feature from a non-targeted feature based, at least in part, on the parameter;
adjusting an emitter to selectively focus the emitter with respect to the targeted feature; and
activating the emitter to direct an emission exclusively and only toward the targeted feature and not toward a non-targeted feature within the operating vicinity.

15. The method of claim 14, further comprising:
training an artificial intelligence model based at least in part on values of the parameter, and thereby to improve a future distinction of the targeted feature from the non-targeted feature.

16. The method of claim 14, wherein activating the emitter comprises directing electromagnetic radiation.

17. The method of claim 14, wherein activating the emitter comprises streaming a chemical composition.

18. A system, comprising a control circuit configured to:
determine a parameter associated with an operating vicinity of the system;
use machine vision to detect a targeted feature based, at least in part, on the parameter;
activate a coupler to selectively aim an emitter at the targeted feature; and
activate the emitter to emit an emission toward the targeted feature while sparing non-targeted features within the operating vicinity.

19. The system of claim 18, wherein the control circuit is disposed on a first vehicle of a plurality of coupled vehicles, and wherein the emitter is disposed on a second vehicle of the plurality of coupled vehicles.

20. The system of claim 18, further comprising a sensor to monitor the parameter, wherein the sensor comprises at least one of an optical sensor, a location sensor, an optical sensor, a temperature sensor, a pressure sensor, or a range finder, or combinations of two or more thereof.
